(19) United States
(12) Patent Application Publication
(10) Pub. No.: US 2020/0107230 A1
(43) Pub. Date: Apr. 2, 2020

(54) ENABLING INTERWORKING BETWEEN MULTIPLE DIFFERENT RADIO ACCESS TECHNOLOGIES

(71) Applicant: QUALCOMM Incorporated, San Diego, CA (US)

(72) Inventors: Suli Zhao, San Diego, CA (US); Stefano Faccin, San Ysidro, CA (US)

(21) Appl. No.: 16/583,046

(22) Filed: Sep. 25, 2019

Related U.S. Application Data
(60) Provisional application No. 62/737,846, filed on Sep. 27, 2018.

(51) Int. Cl. H04W 36/00; H04W 76/11

(52) U.S. Cl. CPC H04W 36/0033; H04W 88/06; H04W 36/0066; H04W 76/11

(57) ABSTRACT

Methods, systems, and devices for wireless communications are described. In some systems, a user equipment (UE) may connect to a network over a packet data network (PDN) connection using a first radio access technology (RAT), such as a second generation (2G) or third generation (3G) RAT. The PDN connection may switch from the first RAT to a second RAT (e.g., a fourth generation (4G) RAT) based on an inter-system change performed by the network and the UE. The UE may transmit a protocol data unit (PDU) session identifier for the PDN connection based on switching to the second RAT. The network may receive the PDU session identifier and determine whether a serving gateway handling the PDN connection supports a third RAT (e.g., a fifth generation (5G) RAT). If the serving gateway supports the third RAT, the network may transmit, to the UE, mapped parameters for communicating using the third RAT.

### CROSS REFERENCE

The present application for patent claims the benefit of U.S. Provisional Patent Application No. 62/737,846 by Zhao et al., entitled “ENABLING INTERWORKING BETWEEN MULTIPLE DIFFERENT RADIO ACCESS TECHNOLOGIES,” filed Sep. 27, 2018, assigned to the assignee hereof, and expressly incorporated by reference in its entirety herein.

### INTRODUCTION

The following relates generally to wireless communications, and more specifically to managing communications between multiple different radio access technologies (RATs).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Some wireless communications systems may include network devices (e.g., base stations) to facilitate wireless communication between a UE and the network. A network that supports communications between a base station and a UE may be referred to as an access network, while a network that supports communications between one or more base stations may be referred to as a backhaul network. In some cases, an access network may support multiple different RATs. For example, the access network may support a second generation (2G) RAT, a third generation (3G) RAT, a 4G RAT, a 5G RAT, or some combination of these. Some UEs may be capable of creating connections with the network using any of these types of RATs. However, some of these network types (e.g., legacy networks, such as 2G or 3G systems) may not support parameters needed for the other network types. As such, the network may not support interworking between all of the different types of RATs supported in the system. Accordingly, a UE cannot maintain a connection with the network when switching between certain types of RATs or through certain sequences of RATs.

### SUMMARY

A method for wireless communications at a UE is described. The method may include communicating with a network over a packet data network (PDN) connection using a first RAT, where the PDN connection is unassociated with a protocol data unit (PDU) session identifier (ID) at the network for the first RAT, performing an inter-system change from the first RAT to a second RAT, and transmitting, to the network using the second RAT, the PDU session ID corresponding to the PDN connection, the transmitting based on the performing the inter-system change from the first RAT to the second RAT and the PDN connection being unassociated with the PDU session ID at the network for the first RAT.

An apparatus for wireless communications at a UE is described. The apparatus may include a processor and memory coupled to the processor. The processor and the memory may be configured to communicate with a network over a PDN connection using a first RAT, where the PDN connection is unassociated with a PDU session ID at the network for the first RAT, perform an inter-system change from the first RAT to a second RAT, and transmit, to the network using the second RAT, the PDU session ID corresponding to the PDN connection, the transmitting based on the performing the inter-system change from the first RAT to the second RAT and the PDN connection being unassociated with the PDU session ID at the network for the first RAT.

Another apparatus for wireless communications at a UE is described. The apparatus may include means for communicating with a network over a PDN connection using a first RAT, where the PDN connection is unassociated with a PDU session ID at the network for the first RAT, performing an inter-system change from the first RAT to a second RAT, and transmitting, to the network using the second RAT, the PDU session ID corresponding to the PDN connection, the transmitting based on the performing the inter-system change from the first RAT to the second RAT and the PDN connection being unassociated with the PDU session ID at the network for the first RAT.

A non-transitory computer-readable medium storing code for wireless communications at a UE is described. The code may include instructions executable by a processor to communicate with a network over a PDN connection using a first RAT, where the PDN connection is unassociated with a PDU session ID at the network for the first RAT, perform an inter-system change from the first RAT to a second RAT, and transmit, to the network using the second RAT, the PDU session ID corresponding to the PDN connection, the transmitting based on the performing the inter-system change from the first RAT to the second RAT and the PDN connection being unassociated with the PDU session ID at the network for the first RAT.

Some examples of the method, apparatuses, and non-transitory computer-readable medium described herein may further include operations, features, means, or instructions for receiving, from the network using the second RAT, a mapped parameter for communication with the network using a third RAT.

Some examples of the method, apparatuses, and non-transitory computer-readable medium described herein may further include operations, features, means, or instructions for selecting a subset of PDN connections from a total set of PDN connections with the network, where the subset of PDN connections may be selected to enable support for performing inter-system changes from the second RAT to the third RAT, the subset of PDN connections includes the PDN connection, and the transmitting may be based on the selecting.

Some examples of the method, apparatuses, and non-transitory computer-readable medium described herein may further include operations, features, means, or instructions for performing an additional inter-system change from the second RAT to the third RAT based on the receiving the mapped parameter for communication with the network using the third RAT, and communicating with the network over the PDN connection using the third RAT.

Some examples of the method, apparatuses, and non-transitory computer-readable medium described herein may further include operations, features, means, or instructions for indicating, to the network, non-access stratum (NAS) capability for the third RAT based on the performing the inter-system change from the first RAT to the second RAT.

In some examples of the method, apparatuses, and non-transitory computer-readable medium described herein, receiving the mapped parameter for communication with the network using the third RAT further may include operations, features, means, or instructions for receiving, from the network, a modify evolved packet system (EPS) bearer context request message including the mapped parameter for communication with the network using the third RAT.

In some examples of the method, apparatuses, and non-transitory computer-readable medium described herein, a serving gateway for the communicating with the network includes a PDN gateway-control (PGW-C)/session management function (SMF) combination gateway, and the receiving the mapped parameter for communication with the network using the third RAT may be based on the serving gateway including the PGW-C/SMF combination gateway.

In some examples of the method, apparatuses, and non-transitory computer-readable medium described herein, the mapped parameter for communication with the network using the third RAT includes a quality of service (QoS) parameter for the third RAT.

In some examples of the method, apparatuses, and non-transitory computer-readable medium described herein, the first RAT includes a global system for mobile communications (GSM) enhanced data rates for GSM evolution (EDGE) radio access network (GERAN) RAT, a universal mobile telecommunication system (UMTS) terrestrial radio access network (UTRAN) RAT, a 2G RAT, a 3G RAT, or a combination thereof, the second RAT includes an LTE RAT, a 4G RAT, an evolved packet core (EPC) RAT, an evolved UTRAN (E-UTRAN) RAT, or a combination thereof, and the third RAT includes a next generation radio access network (NG-RAN) RAT, a 5G RAT, or a combination thereof.

In some examples of the method, apparatuses, and non-transitory computer-readable medium described herein, the inter-system change includes a connected mode handover inter-system change or an idle mode mobility inter-system change.

Some examples of the method, apparatuses, and non-transitory computer-readable medium described herein may further include operations, features, means, or instructions for establishing the PDN connection with the network and generating, for the PDN connection, the PDU session ID corresponding to the PDN connection based on the establishing the PDN connection.

In some examples of the method, apparatuses, and non-transitory computer-readable medium described herein, the PDN connection may be established with the network using the first RAT, and the PDU session ID may be generated transparent to the network for the first RAT.

In some examples of the method, apparatuses, and non-transitory computer-readable medium described herein, the PDN connection may be established with the network using either the second RAT or a third RAT. Some examples of the method, apparatuses, and non-transitory computer-readable medium described herein may further include operations, features, means, or instructions for transmitting, to the network, the PDU session ID corresponding to the PDN connection based on the establishing the PDN connection with the network using either the second RAT or the third RAT, performing an additional inter-system change to the first RAT, where the communicating with the network over the PDN connection using the first RAT may be based on the performing the additional inter-system change to the first RAT, and where the transmitting the PDU session ID corresponding to the PDN connection based on the performing the inter-system change from the first RAT to the second RAT further includes re-transmitting, to the network, the PDU session ID corresponding to the PDN connection based on the performing the additional inter-system change to the first RAT.

In some examples of the method, apparatuses, and non-transitory computer-readable medium described herein, transmitting the PDU session ID corresponding to the PDN connection further may include operations, features, means, or instructions for initiating a bearer resource modification procedure for the PDN connection and transmitting, to the network, a bearer resource modification request message including the PDU session ID corresponding to the PDN connection, where the transmitting the bearer resource modification request message may be based on the initiating the bearer resource modification procedure, and where the bearer resource modification procedure may be triggered based on the performing the inter-system change from the first RAT to the second RAT.

A method for wireless communications at a network device is described. The method may include communicating with a UE, via a serving gateway, over a PDN connection using a first RAT, where the PDN connection is unassociated with a PDU session ID at the network device for the first RAT, performing an inter-system change from the first RAT to a second RAT, and receiving, from the UE using the second RAT, the PDU session ID corresponding to the PDN connection, the receiving based on the performing the inter-system change from the first RAT to the second RAT and the PDN connection being unassociated with the PDU session ID at the network device for the first RAT.

An apparatus for wireless communications at a network device is described. The apparatus may include a processor and memory coupled to the processor. The processor and the memory may be configured to communicate with a UE, via a serving gateway, over a PDN connection using a first RAT, where the PDN connection is unassociated with a PDU session ID at the network device for the first RAT, perform an inter-system change from the first RAT to a second RAT, and receive, from the UE using the second RAT, the PDU session ID corresponding to the PDN connection, the receiving based on the performing the inter-system change from the first RAT to the second RAT and the PDN connection being unassociated with the PDU session ID at the network device for the first RAT.

Another apparatus for wireless communications at a network device is described. The apparatus may include means for communicating with a UE, via a serving gateway, over a PDN connection using a first RAT, where the PDN connection is unassociated with a PDU session ID at the network device for the first RAT, performing an inter-system change from the first RAT to a second RAT, and receiving, from the UE using the second RAT, the PDU session ID corresponding to the PDN connection, the receiving based on the performing the inter-system change from the first RAT to the second RAT and the PDN connection being unassociated with the PDU session ID at the network device for the first RAT.

A non-transitory computer-readable medium storing code for wireless communications at a network device is described. The code may include instructions executable by a processor to communicate with a UE, via a serving gateway, over a PDN connection using a first RAT, where the PDN connection is unassociated with a PDU session ID at the network device for the first RAT, perform an inter-system change from the first RAT to a second RAT, and receive, from the UE using the second RAT, the PDU session ID corresponding to the PDN connection, the receiving based on the performing the inter-system change from the first RAT to the second RAT and the PDN connection being unassociated with the PDU session ID at the network device for the first RAT.

Some examples of the method, apparatuses, and non-transitory computer-readable medium described herein may further include operations, features, means, or instructions for determining, based on the received PDU session ID, whether the serving gateway supports a third RAT.

In some examples of the method, apparatuses, and non-transitory computer-readable medium described herein, the determining whether the serving gateway supports the third RAT further may include operations, features, means, or instructions for determining that the serving gateway supports the third RAT and transmitting, to the UE using the second RAT, a response to the received PDU session ID, the response based on the determination, and where the response includes a mapped parameter for communication with the UE using the third RAT.

In some examples of the method, apparatuses, and non-transitory computer-readable medium described herein, the mapped parameter for communication with the UE using the third RAT includes a set of quality of service parameters for the third RAT.

In some examples of the method, apparatuses, and non-transitory computer-readable medium described herein, transmitting the response comprises operations, features, means, or instructions for transmitting, to the UE, a modify EPS bearer context request message including the mapped parameter for communication with the UE using the third RAT.

Some examples of the method, apparatuses, and non-transitory computer-readable medium described herein may further include operations, features, means, or instructions for performing an additional inter-system change of from the second RAT to the third RAT based on the mapped parameter for communication with the UE using the third RAT and communicating with the UE, via the serving gateway, over the PDN connection using the third RAT.

In some examples of the method, apparatuses, and non-transitory computer-readable medium described herein, determining whether the serving gateway supports the third RAT further may include operations, features, means, or instructions for transmitting the received PDU session ID to the serving gateway.

In some examples of the method, apparatuses, and non-transitory computer-readable medium described herein, determining whether the serving gateway supports the third RAT further may include operations, features, means, or instructions for receiving, from the serving gateway, an indication that the serving gateway received and stored the received PDU session ID and determining that the serving gateway supports the third RAT based on the receiving the indication from the serving gateway.

In some examples of the method, apparatuses, and non-transitory computer-readable medium described herein, determining whether the serving gateway supports the third RAT further may include operations, features, means, or instructions for identifying that an indication may be not received from the serving gateway in response to the transmitting the received PDU session ID during a monitoring period and determining that the serving gateway does not support the third RAT based on the identifying that the indication may be not received during the monitoring period.

In some examples of the method, apparatuses, and non-transitory computer-readable medium described herein, determining whether the serving gateway supports the third RAT further may include operations, features, means, or instructions for verifying whether the serving gateway includes a PGW-C/SMF combination gateway.

Some examples of the method, apparatuses, and non-transitory computer-readable medium described herein may further include operations, features, means, or instructions for selecting the serving gateway for the UE and establishing the PDN connection with the UE using the selected serving gateway.

Some examples of the method, apparatuses, and non-transitory computer-readable medium described herein may further include operations, features, means, or instructions for identifying that the UE supports communication using the third RAT, where selecting the serving gateway further includes selecting a PGW-C/SMF combination gateway for the UE based on the identifying that the UE supports communication using the third RAT.

In some examples of the method, apparatuses, and non-transitory computer-readable medium described herein, receiving the PDU session ID corresponding to the PDN connection further may include operations, features, means, or instructions for receiving, from the UE, a bearer resource modification request message including the PDU session ID corresponding to the PDN connection, where the receiving the bearer resource modification request message may be based on a bearer resource modification procedure initiated by the UE.

In some examples of the method, apparatuses, and non-transitory computer-readable medium described herein, the first RAT includes a GERAN RAT, a UTRAN RAT, a 2G RAT, a 3G RAT, or a combination thereof, the second RAT includes an LTE RAT, an EPC RAT, an E-UTRAN RAT, a 4G RAT, or a combination thereof, and the third RAT includes a NG-RAN RAT, a 5G RAT, or a combination thereof.

### BRIEF DESCRIPTION OF THE DRAWINGS

FIGS. 1 through 3 illustrate examples of wireless communications systems that support enabling interworking between multiple different RATs in accordance with one or more aspects of the present disclosure.

FIG. 4 illustrates an example of a network architecture that supports enabling interworking between multiple different RATs in accordance with one or more aspects of the present disclosure.

FIG. 5 illustrates an example of a process flow that supports enabling interworking between multiple different RATs in accordance with one or more aspects of the present disclosure.

FIGS. 6 and 7 show block diagrams of devices that support enabling interworking between multiple different RATs in accordance with one or more aspects of the present disclosure.

FIG. 8 shows a block diagram of a RAT interworking module that supports enabling interworking between multiple different RATs in accordance with one or more aspects of the present disclosure.

FIG. 9 shows a diagram of a system including a device that supports enabling interworking between multiple different RATs in accordance with one or more aspects of the present disclosure.

FIGS. 10 and 11 show block diagrams of devices that support enabling interworking between multiple different RATs in accordance with one or more aspects of the present disclosure.

FIG. 12 shows a block diagram of a RAT interworking module that supports enabling interworking between multiple different RATs in accordance with one or more aspects of the present disclosure.

FIG. 13 shows a diagram of a system including a device that supports enabling interworking between multiple different RATs in accordance with one or more aspects of the present disclosure.

FIGS. 14 through 18 show flowcharts illustrating methods that support enabling interworking between multiple different RATs in accordance with one or more aspects of the present disclosure.

### DETAILED DESCRIPTION

Some wireless communications systems may include network devices (e.g., base stations) to facilitate wireless communications between a UE and the network. A network that supports communications between a base station and a UE may be referred to as an access network. In some cases, a network may support multiple different RATs for network access. For example, the network may support a 2G RAT, a 3G RAT, a 4G RAT, a 5G RAT, or some combination of these or other types of RATs. Some UEs may be capable of creating connections (e.g., PDN connections) with the network using any of these types of RATs. After creating such a connection with the network using one of the RATs, the UE may switch from initially using this first RAT to using multiple different RATs (e.g., in a series of switches from one RAT to a next). To maintain a PDN connection with the network across multiple RAT switches (e.g., for specific types of RATs), the UE and a network device may communicate additional information related to the PDN connection to support the switching.

For example, the UE may communicate with the network over one or more PDN connections using a first RAT (e.g., a 2G or 3G RAT). In some cases, the PDN connections may not be associated with a PDU session ID at the network for the first RAT. For example, while the UE may generate and store a PDU session ID for a PDN connection using the first RAT (e.g., the 2G or 3G RAT), the UE may not communicate this PDU session ID for the PDN connection to network, as the network may not store PDU session IDs for connections using the first RAT. The UE may switch a set of these PDN connections (e.g., one or more of the PDN connections) from the first RAT to a second RAT (e.g., a 4G RAT). In some cases, switching from the first RAT to the second RAT may be based on a change in the network (e.g., a load on the network), a preference of the UE, or some movement of the UE (e.g., from one network coverage area to another). Switching from the first RAT to the second RAT may be an example of an inter-system change performed by the UE. An inter-system change may be an example of a connected mode handover or idle mode mobility inter-system change from the first RAT to the second RAT. The connected mode handover may occur in cases where the UE may be in a connected mode (e.g., a radio resource control (RRC) connected mode) with the network, and the idle mode mobility may occur in cases where the UE may be in an idle mode (e.g., an RRC idle mode). Switching a connection (e.g., a PDN connection) from the first RAT to the second RAT may involve moving connectivity resources (e.g., user plane resources, radio connection resources, or both) of the connection from the first RAT to another RAT, from a first system to another system, or both.

Switching from the first RAT to the second RAT may trigger the UE to transmit a PDU session ID for any PDN connections successfully transferred to the second RAT that the UE determines may later further transition to a third RAT (e.g., a 5G RAT). For example, the UE may select one or more PDN connections (e.g., connections switched from the first RAT to the second RAT) to support inter-RAT mobility from the second RAT to the third RAT. The UE may transmit a PDU session ID for each of these selected PDN connections, for example, in one or more bearer resource modification request messages. While the network using the first RAT may not have tracked PDU session IDs for the PDN connections (e.g., due to capabilities supported by the first RAT), the network using the second RAT may store the received PDU session IDs (e.g., for the PDN connections using the second RAT).

The network may receive the PDU session IDs and may determine whether a serving gateway handling the corresponding PDN connections supports the third RAT (e.g., the 5G RAT). In some cases, in a bearer resource modification procedure initiated by a bearer resource modification request message, the network may send the received PDU session ID to the serving gateway for storage. If the serving gateway sends, in response, an indication that it has successfully received and stored the PDU session ID, the network may determine that the serving gateway supports transition to the third RAT. Accordingly, the network may transmit mapped parameters to the UE in response to the received PDU session IDs. These mapped parameters may support communication between the UE and the network using the third RAT. Using these mapped parameters, the UE may later switch any of the selected PDN connections from the second RAT to the third RAT. In this way, the UE and network may support inter-RAT mobility from a first RAT (e.g., a 2G or 3G RAT) to a second RAT (e.g., a 4G RAT) to a third RAT (e.g., a 5G RAT) while using a same PDN connection throughout the transitions, without any interruptions to the connectivity of the UE or the UE having to disconnect from the network.

Aspects of the disclosure are initially described in the context of wireless communications systems. Additional aspects of the disclosure are described with respect to a network architecture and a process flow. Aspects of the disclosure are further illustrated by and described with reference to apparatus diagrams, system diagrams, and flowcharts that relate to enabling interworking between multiple different RATs.

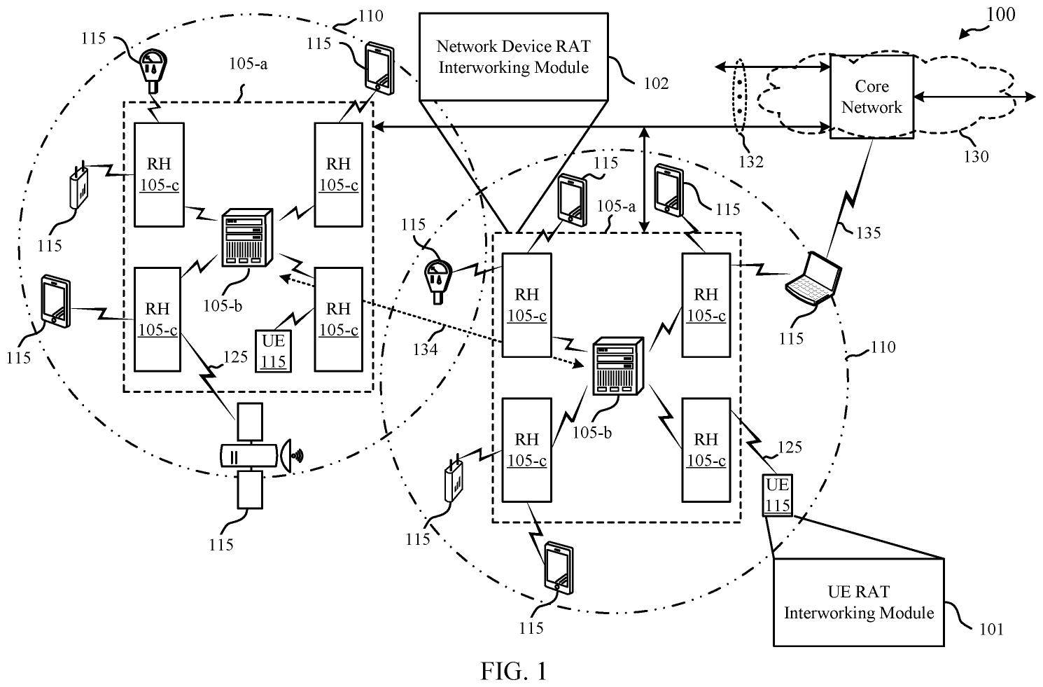

FIG. 1 illustrates an example of a wireless communications system 100 that supports enabling interworking between multiple different RATs in accordance with one or more aspects of the present disclosure. The wireless communications system 100 includes network devices 105, UEs 115, and a core network 130. In some examples, the wireless communications system 100 may be a GERAN network, a UTRAN network, an LTE network, an LTE-A network, an LTE-A Pro network, or an NR network. In some cases, wireless communications system 100 may support enhanced broadband communications, ultra-reliable (e.g., mission critical) communications, low latency communications, or communications with low-cost and low-complexity devices.

The core network 130 may provide user authentication, access authorization, tracking, Internet Protocol (IP) connectivity, and other access, routing, or mobility functions. The core network 130 may be an EPC, which may include at least one mobility management entity (MME), at least one serving gateway, and at least one PDN gateway (PGW). The MME may manage NAS (e.g., control plane) functions such as mobility, authentication, and bearer management for UEs 115 served by network devices 105 associated with the EPC. User IP packets may be transferred through the serving gateway, which itself may be connected to the PGW. The PGW may provide IP address allocation as well as other functions. The PGW may be connected to the network operators IP services. The operators IP services may include access to the Internet, Intranet(s), an IP Multimedia Subsystem (IMS), or a Packet-Switched (PS) Streaming Service.

At least some of the network devices 105 (e.g., a network device 105-a, which may be an example of a base station (e.g., an eNodeB (eNB), a set of network access devices, a next-generation Node B or giga-nodeB (either of which may be referred to as a gNB), etc.), or network device 105-b, which may be an example of an access node controller (ANC)), may interface with the core network 130 through backhaul links 132 (e.g., S1, S2) and may perform radio configuration and scheduling for communication with the UEs 115. In various examples, the network devices 105-b may communicate, either directly or indirectly (e.g., through core network 130), with each other over backhaul links 134 (e.g., X1, X2), which may be wired or wireless communication links.

Each network device 105-b may also additionally or alternatively communicate with a number of UEs 115 through a number of other network devices 105-c, where a network device 105-c may be an example of a smart radio head, or may communicate through a number of smart radio heads. In alternative configurations, various functions of each network device 105 may be distributed across various network devices 105 (e.g., radio heads, ANCs, or both) or consolidated into a single network device 105 (e.g., a base station).

A network device 105 may wirelessly communicate with UEs 115 via one or more base station antennas. Network devices 105 described herein may include or may be referred to by those skilled in the art as base transceiver stations, radio base stations, access points, radio transceivers, NodeBs, eNBs, gNBs, Home NodeBs, Home eNodeBs, or some other suitable terminology. Wireless communications system 100 may include network devices 105 of different types (e.g., macro or small cell base stations). The UEs 115 described herein may be able to communicate with various types of network devices 105 and network equipment including macro eNBs, small cell eNBs, gNBs, relay base stations, and the like.

Each network device 105 may be associated with a particular geographic coverage area 110 in which communications with various UEs 115 is supported. Each network device 105 may provide communication coverage for a respective geographic coverage area 110 via communication links 125, and communication links 125 between a network device 105 and a UE 115 may utilize one or more carriers. Communication links 125 shown in wireless communications system 100 may include uplink transmissions from a UE 115 to a network device 105, or downlink transmissions from a network device 105 to a UE 115. Downlink transmissions may also be called forward link transmissions while uplink transmissions may also be called reverse link transmissions.

The geographic coverage area 110 for a network device 105 may be divided into sectors making up only a portion of the geographic coverage area 110, and each sector may be associated with a cell. For example, each network device 105 may provide communication coverage for a macro cell, a small cell, a hot spot, or other types of cells, or various combinations thereof. In some examples, a network device 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same network device 105 or by different network devices 105. The wireless communications system 100 may include, for example, a heterogeneous LTE/LTE-A/LTE-A Pro or NR network in which different types of network devices 105 provide coverage for various geographic coverage areas 110.

The term “cell” refers to a logical communication entity used for communication with a network device 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like. A UE 115 may communicate with the core network 130 through communication link 135.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a network device 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a network device 105. Other UEs 115 in such a group may be outside the geographic coverage area 110 of a network device 105, or be otherwise unable to receive transmissions from a network device 105. In some cases, groups of UEs 115 communicating via D2D communications may utilize a one-to-many (1:M) system in which each UE 115 transmits to every other UE 115 in the group. In some cases, a network device 105 facilitates the scheduling of resources for D2D communications. In other cases, D2D communications are carried out between UEs 115 without the involvement of a network device 105.

Network devices 105 may communicate with the core network 130 and with one another. For example, network devices 105 may interface with the core network 130 through backhaul links 132 (e.g., via an S1, N2, N3, or another interface). Network devices 105 may communicate with one another over backhaul links 134 (e.g., via an X2, Xn, or other interface) either directly (e.g., directly between network devices 105) or indirectly (e.g., via core network 130).

At least some of the network devices, such as a network device 105, may include subcomponents such as an access network entity, which may be an example of an ANC. Each access network entity may communicate with UEs 115 through a number of other access network transmission entities, which may be referred to as a radio head, a smart radio head, or a transmission/reception point (which may be known as a transmission/reception point (TRP); however, in the present disclosure, TRP will be assumed to stand for total radiated power unless otherwise specified). In some configurations, various functions of each access network entity or network device 105 may be distributed across various network devices (e.g., radio heads and ANCs) or consolidated into a single network device (e.g., a network device 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and network devices 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as network devices 105 and UEs 115 may employ listen-before-talk (LBT) procedures to ensure a frequency channel is clear before transmitting data. In some cases, operations in unlicensed bands may be based on a carrier aggregation (CA) configuration in conjunction with component carriers (CCs) operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, network device 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a network device 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a network device 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the antennas of a network device 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a network device 105 may be located in diverse geographic locations. A network device 105 may have an antenna array with a number of rows and columns of antenna ports that the network device 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a network device 105 or core network 130 supporting radio bearers for user plane data. At the Physical layer, transport channels may be mapped to physical channels.

In some cases, UEs 115 and network devices 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a network device 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an Evolved Universal Terrestrial Radio Access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple subcarriers (e.g., using multi-carrier modulation (MCM) techniques such as orthogonal frequency division multiplexing (OFDM) or DFT-s-OFDM).

The organizational structure of the carriers may be different for different radio access technologies (e.g., GERAN, UTRAN, LTE, LTE-A, LTE-A Pro, EPC, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., network devices 105 or UEs 115) may have a hardware configuration that supports communications over a particular carrier bandwidth, or may be configurable to support communications over one of a set of carrier bandwidths. In some examples, the wireless communications system 100 may include network devices 105 and/or UEs 115 that can support simultaneous communications via carriers associated with more than one different carrier bandwidth.

Wireless communications system 100 may support communication with a UE 115 on multiple cells or carriers, a feature which may be referred to as CA or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or network device 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

In some cases, multiple systems supporting wireless communications may be deployed. UEs 115 may support switching between some of these systems based on system capabilities or procedures. For example, a UE 115 may connect to one system with a PDN connection and, at a later time, may switch the PDN connection to a second system. The UE 115 may switch the PDN connection by performing an inter-system change. Based on the capabilities of the UE 115, the UE 115 may additionally generate a PDU session ID associated with the PDN connection when initially creating the PDN connection. However, in some examples, a first system may not use PDU session IDs and may not support processing or storing information related to PDU session IDs. A second system may not use PDU session IDs but may store or process information related to PDU session IDs. A third system may use, store, and process PDU session IDs. As such, a UE 115 switching between this first, second, and third system may perform operations to handle tracking of PDU session information across systems. In some implementations, the first system may be served by a first RAT, the second system may be served by a second RAT, and the third system may be served by a third RAT for network access. In one specific example, the first RAT may be an example of a 2G and/or 3G RAT, the second RAT may be an example of a 4G RAT, and the fifth RAT may be an example of a 5G RAT. However, in other examples, these systems, RATs, or both may be referred to by different terms or names. Additionally, other systems with different levels of PDU session support (e.g., systems of generations beyond 5G) may interact with one or more of these systems and may support any of the operations described herein.

Some UEs 115 may be capable of creating connections with the network (e.g., via a network device 105) using any of the supported types of RATs. After creating such a connection with the network using one of the RATs, the UE 115 may switch from initially using this first RAT to using a second RAT, then a third RAT, etc., in a series of switches from one RAT to the next. To maintain a PDN connection with the network across multiple RAT switches, the UE 115 and a network device 105 may communicate additional information related to the PDN connection to check for inter-RAT mobility capabilities (e.g., from a 2G/3G RAT to a 4G RAT to a 5G RAT).

For example, the UE 115 may communicate with the network over one or more PDN connections using a first RAT (e.g., a 2G or 3G RAT). The UE 115 may switch at least one of these PDN connections from the first RAT to a second RAT (e.g., a 4G RAT). In some cases, switching from the first RAT to the second RAT may be based on a change in the network (e.g., a load on the network), a preference of the UE 115, or some movement of the UE 115 (e.g., from one geographic coverage area 110 to another). Switching from the first RAT to the second RAT may trigger the UE 115 to transmit a PDU session ID for a PDN connection such that the UE may determine if the PDN connection supports further mobility to a third RAT (e.g., a 5G RAT). While the network using the first RAT may not track PDU session IDs for PDN connections (e.g., due to capabilities supported by the first RAT), the network using the second RAT may store the PDU session ID received from the UE 115. In some cases, identifying the switch from the first RAT to the second RAT and, accordingly, transmitting the PDU session ID for a PDN connection may be performed by a UE RAT interworking module 101 at the UE 115.

The network (e.g., via a network device 105) may receive the PDU session ID from the UE 115 and may determine whether a serving gateway handling the corresponding PDN connection supports the third RAT (e.g., the 5G RAT). For example, the network may send the received PDU session ID to the serving gateway for storage. If the serving gateway responds with an indication that the PDU session ID has been successfully received and stored at the serving gateway, the network may determine that the serving gateway for the PDN connection supports transition to the third RAT. Accordingly, the network (e.g., via the network device 105) may transmit mapped parameters to the UE 115 in response to the received PDU session ID. These mapped parameters may support communication between the UE 115 and the network using the third RAT. In some cases, determining whether the serving gateway supports the third RAT and transmitting the mapped parameters may be performed by a network device RAT interworking module 102 at a network device 105.

By using the received mapped parameters, the UE 115 may switch the PDN connection from the second RAT to the third RAT based on the capabilities of the serving gateway. Using these signals to check for inter-RAT mobility support allows the UE 115 and the network to maintain a PDN connection from the first RAT (e.g., a 2G or 3G RAT), to the second RAT (e.g., a 4G RAT), to the third RAT (e.g., a 5G RAT) without the UE 115 disconnecting the PDN connection from the network.

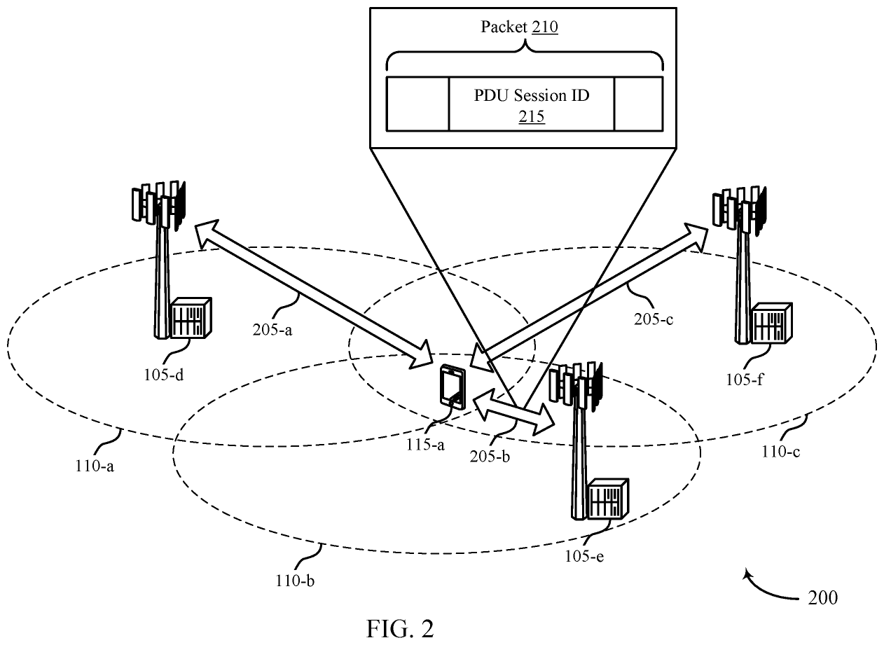

FIG. 2 illustrates an example of a wireless communications system 200 that supports enabling interworking between multiple different RATs in accordance with one or more aspects of the present disclosure. The wireless communications system 200 may include network devices 105-d, 105-e, and 105-f, which may be examples of base stations, and UE 115-a. These may be examples of the corresponding devices described with reference to FIG. 1. The network devices 105-d, 105-e, and 105-f may provide coverage for geographic coverage areas 110-a, 110-b, and 110-c. In some cases, one or more of these geographic coverage areas may overlap. A UE 115 operating within the overlapping coverage areas 110 may communicate with the network using any of the RATs supported by the corresponding network devices 105. In some cases, communication links 205-a, 205-b, and 205-c may correspond to a same PDN connection between the UE 115-a and the network using different RATs (e.g., a first RAT for communication link 205-a, a second RAT for communication link 205-b, and a third RAT for communication link 205-c).

A network architecture may employ both legacy (e.g., 2G/3G or 4G) and next generation (e.g., 5G) communication networks. For example, as illustrated, network devices 105-d, 105-e, and 105-f may support 2G/3G, 4G, and 5G operations in geographic coverage areas 110-a, 110-b, and 110-c, respectively. The network may support a number of RATs corresponding to a given network deployment (e.g., including but not limited to a 2G/3G RAT, a 4G RAT, and a 5G RAT). The network architecture may further contain one or more UEs 115, including UE 115-a. In some cases, an access network may pass information between the UE 115-a and a core network and may indicate a set of resources available to the UE 115-a. The access network may be an example of one or more network components, access nodes, or both. In addition, the access network may utilize different RATs for communication within the network and across multiple networks. In one example, a first RAT may be a GERAN RAT, or a UTRAN RAT. In some cases, this first RAT may be referred to as a 2G RAT, a 3G RAT, or a 2G/3G RAT. A second RAT may be an LTE RAT, an EPC RAT, or an E-UTRAN RAT. This second RAT may be referred to as a 4G RAT. A third RAT may be an NG-RAN RAT. This third RAT may be referred to as a 5G RAT. The UE 115-a may support switching between several different RATs during a given communication period. UE 115-a may switch between different RATs by performing an inter-system change between RATs (e.g., from a first RAT to a second RAT). In one implementation, the UE 115-a may communicate with the core network using a first RAT (e.g., a 2G/3G RAT) before switching to a second RAT (e.g., a 4G RAT), and then may switch to a third RAT (e.g., a 5G RAT). In other implementations, the UE 115-a may communicate using a second or third RAT, switch to communicating using a first RAT, and then switch back to the second and then the third RAT. Any amount or sequence of inter-RAT switching may be supported by the wireless communications system 200.

In some cases, the UE 115-a may have 5G system (5GS) functionality. UE 115-a may be configured to support 5G core network (5GC) NAS capabilities in addition to other capabilities. For example, UE 115-a may support 2G/3G NAS capabilities and Evolved Packet Core (EPC) 4G NAS capabilities in addition to 5G NAS capabilities. In one case, a UE 115-a that supports both 5GC and EPC NAS may operate in a single-registration mode with one active state (e.g., the UE 115-a operates in either 5GC or EPC mode at any moment in time) and, accordingly, may keep a single coordinated registration with the network for both 5GC and EPC. In other cases, a UE 115-a may operate in dual-registration mode and may handle independent registrations with the network for 5GC and EPC, where it may support 5GC only, EPC only, or both 5GC and EPC.

In one example, a UE 115-a capable of 5GS interworking may communicate with a network via a PDN connection using a first RAT (e.g., a 2G/3G RAT) over communication link 205-a. In a second example, a UE 115-a capable of 5GS interworking may communicate with the network via a PDN connection using a second RAT (e.g., a 4G RAT) over communication link 205-b. In some examples, the UE 115-a may switch from communicating with the network using the first RAT to communicating with the network using the second RAT based on changing network conditions (e.g., the load on the network), the operations to perform (e.g., such as RAT-specific operations), moving between network coverages, or any other reason for triggering a network switch. The UE 115-a may transmit a PDU session ID 215 corresponding to the PDN connection based on switching to the second RAT. For example, switching from the first RAT to the second RAT may trigger the UE 115-a to transmit a packet 210 containing the PDU session ID 215 to a network device 105 associated with a third RAT (e.g., a 5G RAT) via a communication link 205 (e.g., using the second RAT).

In some cases, the UE 115-a may transmit a set of PDU session IDs 215 corresponding to a number of established PDN connections. The UE 115-a may further determine the handover priority for PDU sessions corresponding to the set of PDU session IDs 215. For example, the UE 115-a may indicate the handover priority of a PDU session based on establishment time, and the network may determine a number of PDU sessions to transfer based on determined handover priority. In one example, the UE 115-a may send an indication to the network that it is switching from one RAT to a different RAT using a tracking area update (TAU) or a similar attach procedure.

The UE 115-a may initiate a bearer resource modification procedure for the established PDN connection to transition from the first RAT to the second RAT. The UE 115-a may transmit, to the network as part of the bearer resource modification procedure, the PDU session ID 215 for the PDN connection in a bearer resource modification request message. In examples where the network supports communication using the third RAT, the UE 115-a may receive a set of mapped parameters (e.g., QoS parameters) to support communication with the network using the third RAT. The set of parameters may include network information such as a QoS class identifier, allocation and priority information, bit rate information related to network communication using the third RAT, or any other information related to communicating using the third RAT. In some cases, the UE 115-a may receive the parameters within a modify EPS bearer context request message. This modify EPS bearer context request message may initiate another bearer resource modification procedure (e.g., for switching from the second RAT to the supported third RAT), which may include the UE 115-a verifying an EPS bearer identity based on the modify EPS bearer context request message. The UE 115-a may transmit a modify EPS bearer context accept message to the network. The UE 115-a may indicate the existing PDU session switched from the second RAT to the third RAT in such transmissions.

In one implementation, a UE 115-a may establish a PDN connection with the network using the first RAT. If UE 115-a is an example of a 5GC-capable UE (e.g., UE 115-a supports connectivity to a 5G system in addition to 2G/3G and 4G systems), UE 115-a may generate a PDU session ID 215 associated with the PDN connection when establishing the PDN connection in the first RAT (e.g., based on the support 5G NAS). However, UE 115-a may not indicate this PDU session ID 215 to the network using the first RAT based on the capabilities of the network (e.g., the network using the first RAT may not use PDU session IDs 215 and, correspondingly, may not support processing or storing of PDU session information). If the UE 115-a switches from using the first RAT to using a second RAT that can store PDU session information, UE 115-a may transmit the PDU session ID 215 to the network.

In another implementation, the UE 115-a may transmit a PDU session ID 215 to the network upon establishing a PDN connection using the second or third RAT. The UE 115-a may then switch the PDN connection to communicate with the network using the first RAT. The network using the first RAT may not store an indication of the PDU session ID 215. For example, the first RAT may not support or be capable of tracking PDU session IDs 215 for PDN connections. As such, the network may lose the PDU session context when the UE 115-a switches from the second RAT to the first RAT. If the UE 115-a then switches the PDN connection from the first RAT back to the second RAT, the UE 115-a may re-transmit the PDU session ID 215 to the network. In this way, the network using the second RAT (e.g., a RAT that supports or is capable of maintaining PDU session contexts) may determine the PDU session ID for the PDN connection transitioning from the first RAT to the second RAT.

A UE 115-a may communicate with the network by utilizing a variety of access nodes or serving gateways. In some cases, the serving gateway for a PDN connection may be a PGW and may serve as a network entry or exit point for data traffic of the UE 115-a. In addition, the PGW may provide other means for the UE 115-a to switch between network architectures. In some examples, the UE 115-a may connect with one or more PGWs during communication. In some implementations, the gateway may be a PGW-C/SMF combination gateway that supports switching between the second RAT and the third RAT (e.g., 4G-to-5G inter-RAT switching). When the UE 115-a transmits the PDU session ID 215 corresponding to the PDN connection transitioned from the first RAT to the second RAT, the network may check the gateway to determine whether the gateway supports further transitioning to the third RAT. To check the serving gateway, the network (e.g., a mobility management entity (MME) of the network) may send the PDU session ID 215 to the serving gateway (e.g., during a UE initiated bearer resource modification procedure). If the serving gateway for the corresponding PDN connection is a PGW-C/SMF combination gateway, the gateway may store the PDU session ID 215 and may transmit a verification to back to the network (e.g., the MME) confirming that the PDU session ID 215 is stored at the serving gateway. This indication may confirm that the serving gateway recognizes the PDU session ID 215. Accordingly, based on this indication, the network may determine that the serving gateway is a type of gateway (e.g., a PGW-C/SMF combination gateway) that supports the third RAT (e.g., 5G). The network may transmit a set of parameters to the UE 115-a indicating that the network supports communication using the third RAT over the PDN connection via the PGW-C/SMF combination gateway.

In other implementations, the UE 115-a may send a PDU session ID 215 in a bearer resource modification request message over a PDN connection with a serving gateway that is not a PGW-C/SMF combination gateway. This serving gateway may not support communication using the third RAT. As such, if the network (e.g., an MME) transmits the PDU session ID 215 to the serving gateway for storage, the gateway may not store the PDU session ID 215 corresponding to the PDN connection transitioning from the second RAT to the third RAT. In some cases, the serving gateway may not send a message indicating either successful or unsuccessful storage of the transmitted PDU session ID. In other cases, the serving gateway may transmit a response message based on receiving the PDU session ID 215 that indicates the serving gateway did not identify what to do with the received PDU session ID 215 or did not store the PDU session ID 215. Based on either of these (e.g., no response or a response not indicating successful storage), the network may determine that the serving gateway is not a PGW-C/SMF combination gateway and, as such, does not support 5G switching. In some cases, the network may not send a response to the PDU session ID 215 (e.g., in the bearer resource modification request message) received from the UE 115-a. In other cases, the network may transmit a rejection message in response to the bearer resource modification request message to indicate that the serving gateway for the PDN connection does not support 5G switching or communication using the third RAT. In these implementations, the UE 115-a may not switch from the second RAT to the third RAT and maintain the same PDN connection, as the serving gateway for the PDN connection does not support or is not capable of using the third RAT (e.g., 5G).

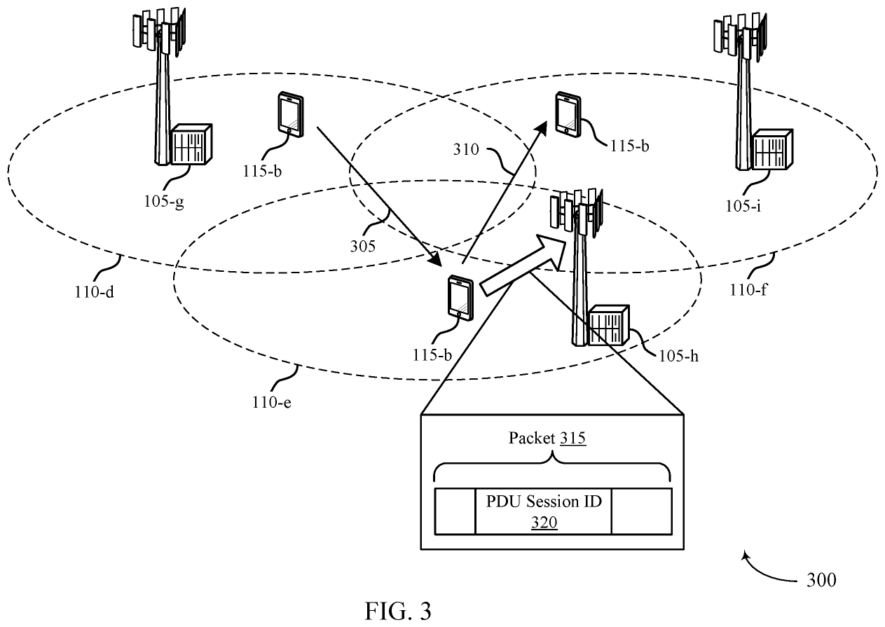

FIG. 3 illustrates an example of a wireless communications system 300 that supports enabling interworking between multiple different RATs in accordance with one or more aspects of the present disclosure. In the wireless communications system 300, a UE 115 (e.g., UE 115-b) may establish a PDN connection with a network using a first RAT while located in geographic coverage area 110-d, which may correspond to 2G/3G (GERAN/UTRAN) network coverage. Additionally, the UE 115-b may generate a PDU session ID corresponding to the established PDN connection using the first RAT. Then, at 305, the UE 115-b may move to a second geographic coverage area 110-e and may switch the PDN connection from the first RAT to a second RAT. The switch of the PDN connection from the first RAT to the second RAT may be an example of an inter-system change from the first RAT to the second RAT. For example, UE 115-b may perform an inter-system change, such as a connected mode handover inter-system change or an idle mode mobility inter-system change, from the first RAT to the second RAT. In some examples, the second geographic coverage area 110-e may correspond to 4G (LTE/EPC) network coverage. UE 115-b may maintain the PDU session—and the corresponding PDU session ID—with the network during the inter-RAT switching. At 310, UE 115-b may then move to a third geographic coverage area 110-f, which may correspond to 5G (NR) network coverage. In some cases, the geographic coverage areas 110-d, 110-e, and 110-f may correspond to different network devices 105-g, 105-h, and 105-i, respectively.

To determine which PDN connections maintained from the first RAT to the second RAT support further transitioning to the third RAT, the UE 115-b may transmit one or more packets 315 that contain a PDU session ID 320 for each of the PDN connections the UE 115-b may transition to the third RAT. The UE 115-b may transmit the PDU session IDs 320 (e.g., using a TAU or a bearer resource modification procedure) to a network device 105, such as network device 105-h using the second RAT. In some cases, the UE 115-b may transmit the PDU session ID(s) 320 upon switching the PDN connections from the first RAT to the second RAT. In other cases, the UE 115-b may transmit the PDU session ID(s) 320 when identifying the network coverage for the third RAT (and, accordingly, the opportunity to switch the PDN connections from the second RAT to the third RAT). Each PDN connection that is handled on the network-side by a PGW-C/SMF combination gateway may support communication using a third RAT (e.g., these PDN connections may support 5G switching). Upon receiving the PDU session ID(s) 320 from UE 115-b, the network may store the PDU session ID(s) 320, and may transmit mapped resources to UE 115-b for any PDN connections that support transitioning to the third RAT (e.g., based on the type of serving gateway for each PDN connection). The UE 115-b may then switch from the second RAT to the third RAT, and the UE 115-b may maintain any PDN connections corresponding to a PGW-C/SMF combination gateway for communications using the third RAT. In this way, some or all of the PDN connections established in the geographic coverage area 110-d serving a 2G/3G network may transition to serving a 5G network in the geographic coverage area 110-f without disconnecting from the network.

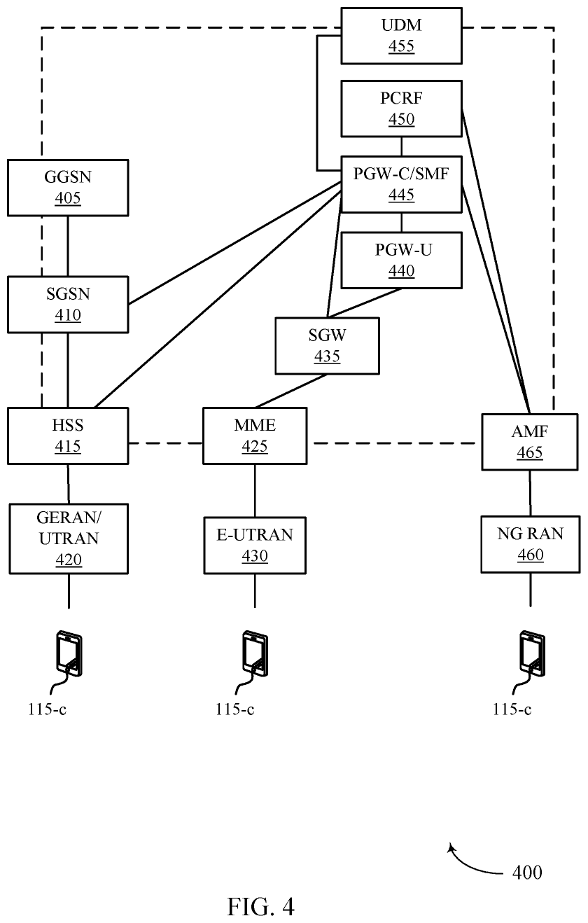

FIG. 4 illustrates an example of a network architecture 400 that supports enabling interworking between multiple different RATs in accordance with one or more aspects of the present disclosure. In the network architecture 400, a UE 115-c may be capable of procedures using multiple RATs. For example, the UE 115-c may be capable of supporting operations using a first RAT (e.g., in 2G/3G networks, such as GERAN/UTRAN networks), a second RAT (e.g., in 4G networks, such as LTE/EPC networks), or a third RAT (e.g., in 5G networks, such as NG-RAN networks supporting 5GC NAS procedures). In such an example, the UE 115-c may use procedures associated with the first, second or third RAT depending on the network it may is currently accessing. In some cases, the UE 115-c may switch between one or more of these RATs when roaming. In some examples, the UE 115-c may maintain a PDU session and corresponding PDN connection throughout this switching procedure. However, a UE 115 may not switch a PDN connection directly between certain RATs (e.g., from a GERAN/UTRAN RAT to a NG-RAN RAT) because of certain differences in parameters, capabilities, or network structure. The UE 115-c may instead switch certain PDN connections from a network using a first RAT to a network using a second RAT and may additionally switch the PDN connections from the network using the second RAT to a network using a third RAT. Switching the PDN connections may be examples of performing inter-system changes. In this way, the UE 115-c may transition a PDN connection from a first RAT to a third RAT that do not support direct inter-RAT switching through an intermediate RAT (e.g., the second RAT).

A network may employ a number of devices to facilitate communications and forward packet data between different RATs. In a network structure corresponding to the first RAT (e.g., a GERAN/UTRAN RAT 420), a gateway general packet radio service (GPRS) support node (GGSN) 405 may interwork between the network associated with the first RAT and other external packet switched networks and may further coordinate with a serving GPRS support node (SGSN) 410. The SGSN 410 may confirm the location of UE 115-c and, among other functions, may transmit and/or receive data from one or more UEs 115 within the network (e.g., UE 115-c). The SGSN 410 may be connected to (or a component of) a serving gateway or node. In some cases, this serving gateway may be an example of a PGW-C/SMF combination node 445. The network corresponding to the first RAT may additionally utilize a home subscriber server (HSS) 415 for identifying subscription information for UE 115-c. In the case of interworking between networks utilizing the first RAT and the second RAT, the HSS 415 may additionally give information to a mobile management entity (MME) 425 for the second RAT (e.g., an E-UTRAN RAT 430). The network devices described may work with a number of other network devices 105 to transfer connections from a first RAT to a second RAT. As such, the UE 115-c may maintain a PDN connection for the GERAN/UTRAN RAT 420 as a PDN connection for the E-UTRAN RAT 430 using the same serving gateway corresponding to the PGW-C/SMF combination node 445.

In some examples, the UE 115-c with a connection to a network using E-UTRAN RAT 430 may switch, in an inter-system change process, to a network supporting communications using a third RAT (e.g., an NG RAN RAT 460). A number of network devices may serve to coordinate communication between networks utilizing the second and third RATs. MME 425 may send information to a serving gateway 435, which may be an example of or a component of the PGW-C/SMF combination node 445. The serving gateway 435 may establish a number of sessions (e.g., PDU sessions) for a particular UE 115-c. The serving gateway 435 may also serve as an interface between MME 425 and a user PDN Gateway (PGW-U) 440. the PGW-U 440 may communicate with a PGW-C/SMF combination node 445, a policy and charging rules function (PCRF) 450 and user data management (UDM) 455 as part of communications using the third RAT. The structure supporting communication between the second and third RATs may also include an authentication management field (AMF) 465 for timing and other synchronization purposes at both the NG RAN RAT 460 and UE 115-c.

Due to the network architecture 400 (or a similar network architecture), a 5GS interworking capable UE 115 may transition a PDN connection and corresponding PDU session between the different RATs if the PDN connection is served by a PGW-C/SMF combination node 445. In some cases, if the network identifies a 5GS interworking capable UE 115 during a connection establishment procedure (e.g., if the UE 115-c connects to the network using an E-UTRAN RAT 430 or an NG RAN RAT 460), the network may select a PGW-C/SMF combination node 445 for the connection to support inter-RAT mobility. However, if the network does not identify whether the UE 115 is a 5GS interworking capable UE 115 (e.g., if the UE 115-c connects to the network using a GERAN/UTRAN RAT 420), the network may select a serving gateway or node according to another procedure (e.g., a random procedure, according to other parameters or capabilities, etc.). In these cases, if a serving gateway or node is selected for a PDN connection that is not a PGW-C/SMF combination node 445, the network architecture 400 may not support a UE 115 transitioning a PDN connection from either a first RAT or second RAT (e.g., a GERAN/UTRAN RAT 420 or an E-UTRAN RAT 430) to a third RAT (e.g., an NG RAN RAT 460), even if the UE 115 is a 5GS interworking capable UE 115.

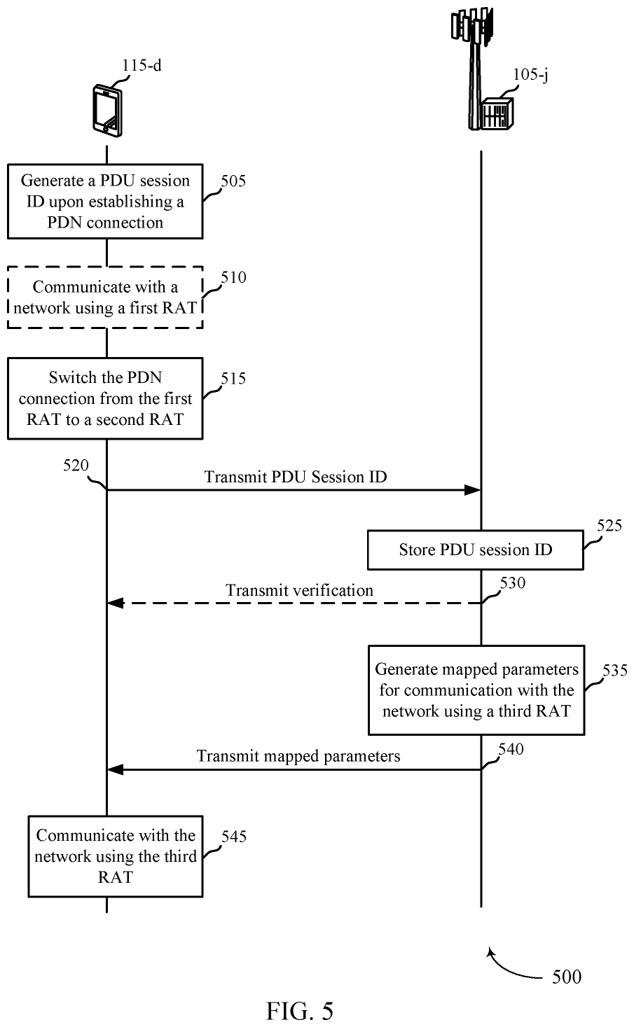

FIG. 5 illustrates an example of a process flow 500 that supports enabling interworking between multiple different RATs in accordance with one or more aspects of the present disclosure. The process flow may include a UE 115-d and a network device 105-j, which may be examples of the corresponding devices described with reference to FIGS. 1 through 4. UE 115-d may communicate with a network using a number of RATs corresponding to different network configurations and may facilitate interworking between different networks (e.g., 3G-to-EPS-to-5GS interworking). The network device 105-j may be an example of an access and mobility management function (AMF) or a device implementing an AMF. Alternative examples of the following may be implemented, where some processes are performed in a different order than described or are not performed at all. In some cases, processes may include additional features not mentioned below, or further processes may be added.

At 505, UE 115-d may establish a PDN connection with a network (e.g., via network device 105-j). For example, UE 115-d may establish this PDN connection using a first RAT. In some cases, the first RAT may be an example of a 2G/3G (e.g., GERAN/UTRAN) RAT. UE 115-d may generate a PDU session ID for the PDN connection upon establishing the PDN connection. UE 115-d may generate different PDU session IDs for different PDN connections it maintains with the network. As such, the UE 115-d may generate one or many PDU session IDs based on the connections between the UE 115-d and the network. In some cases, rather than creating the PDN connection using the first RAT, UE 115-d may create the PDN connection using another RAT and then may switch the PDN connection to the first RAT. In these cases, UE 115-d may still generate the PDU session ID when establishing the PDN connection and may maintain the PDU session ID in memory when switching to the first RAT.

In some examples, at 510, UE 115-d may communicate with the network using the first RAT. Additionally or alternatively, the network may communicate with UE 115-d over the PDN connections using the first RAT and one or more serving gateways. In some cases, the PDN connection may be unassociated with a PDU session ID at the network for the first RAT. For example, the network may not store a PDU session ID for the PDN connection associated with the first RAT.

At 515, UE 115-d may switch between communicating with the network using the first RAT to communicating with the network using a second RAT. In some cases, the second RAT may be an example of a 4G (e.g., LTE/EPC) RAT. In cases where UE 115-d switches between communicating with the network using the first RAT to communicating with the network using the second RAT, UE 115-d may perform an inter-system change from the first RAT to the second RAT. In some cases, the inter-system change may be an example of a connected mode handover (i.e., when UE 115-d is in a connected mode, such as an RRC connected mode) or an idle mode mobility operation (i.e., when UE 115-d is in an idle mode, such as an RRC idle mode).

For a PDN connection transitioned from the first RAT to the second RAT to support further transitioning from the second RAT to a third RAT, UE 115-d may transmit, at 520, the PDU session ID corresponding to the PDN connection to the network (via network device 105-j). In some of these cases, UE 115-d may transmit the PDU session ID for the PDN connection to the network when switching to the second RAT based on the PDN connection being unassociated with a PDU session ID at the network for the first RAT. In some cases, the third RAT may be an example of a 5G (e.g., NG-RAN) RAT. UE 115-d may transmit PDU session IDs to the network for all PDN connections switched from the first RAT to the second RAT or for a subset of the PDN connections switched from the first RAT to the second RAT. For example, UE 115-d may transmit PDU session IDs corresponding to PDN connections that UE 115-d has elected to transfer from the second RAT to the third RAT. UE 115-c may transmit the PDU session ID using the second RAT, where the transmitting is based on switching the PDN connection (e.g., performing an inter-system change) from the first RAT to the second RAT. In some cases, the network device 105-j may be an example of a PGW-C/SMF combination gateway that supports communications using the third RAT.

At 525, the network device 105-j (e.g., the PGW-C/SMF combination gateway) may store the PDU session ID corresponding to the PDN connection, and at 530 may transmit a verification message to UE 115-d that the PDU session ID has been stored. In some cases, this verification message may be transmitted internal to the network. For example, an MME for the network may send the PDU session ID to the PGW-C/SMF combination gateway for storage, and the PGW-C/SMF combination gateway may respond to the MME if the PDU session ID is stored successfully at the PGW-C/SMF combination gateway.

At 535, the network device 105-j (e.g., the PGW-C/SMF combination gateway) may generate a set of mapped parameters (e.g., 5G QoS parameters) that facilitate communication between UE 115-d and the network using the third RAT. This set of mapped parameters may include one or more parameters.

At 540, the network device 105-j (e.g., the PGW-C/SMF combination gateway) may transmit the set of mapped parameters for communication with the network using the third RAT to UE 115-d. The network device 105-j may transmit the set of mapped parameters using the second RAT. The transmission of the set of mapped parameters at 540 may be based on a determination of whether the serving gateway supports the third RAT.

At 545, the UE 115-d may receive the set of mapped parameters and may switch PDN connections that support interworking between the second RAT and the third RAT from the second RAT to the third RAT. The PDN connection switch may be an example of UE 115-d performing an additional inter-system change from the second RAT to the third RAT based on receiving the set of mapped parameters. The UE 115-d may subsequently communicate with the network using this third RAT and the maintained PDN connection or connections, where the network continues to use the PGW-C/SMF combination gateway or gateways to serve these PDN connections.

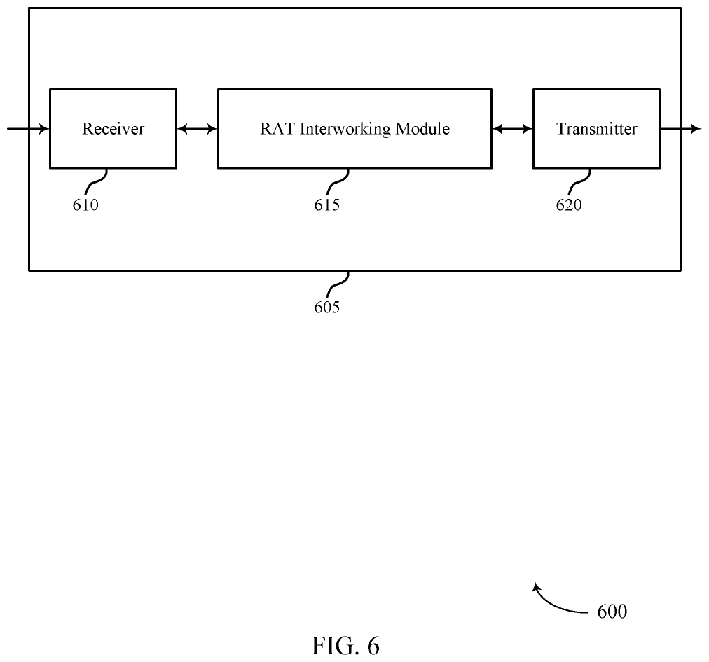

FIG. 6 shows a block diagram 600 of a device 605 that supports enabling interworking between multiple different RATs in accordance with one or more aspects of the present disclosure. The device 605 may be an example of aspects of a UE 115 as described herein. The device 605 may include a receiver 610, a RAT interworking module 615, and a transmitter 620. The device 605 may also include a processor. Each of these components may be in communication with one another (e.g., via one or more buses).

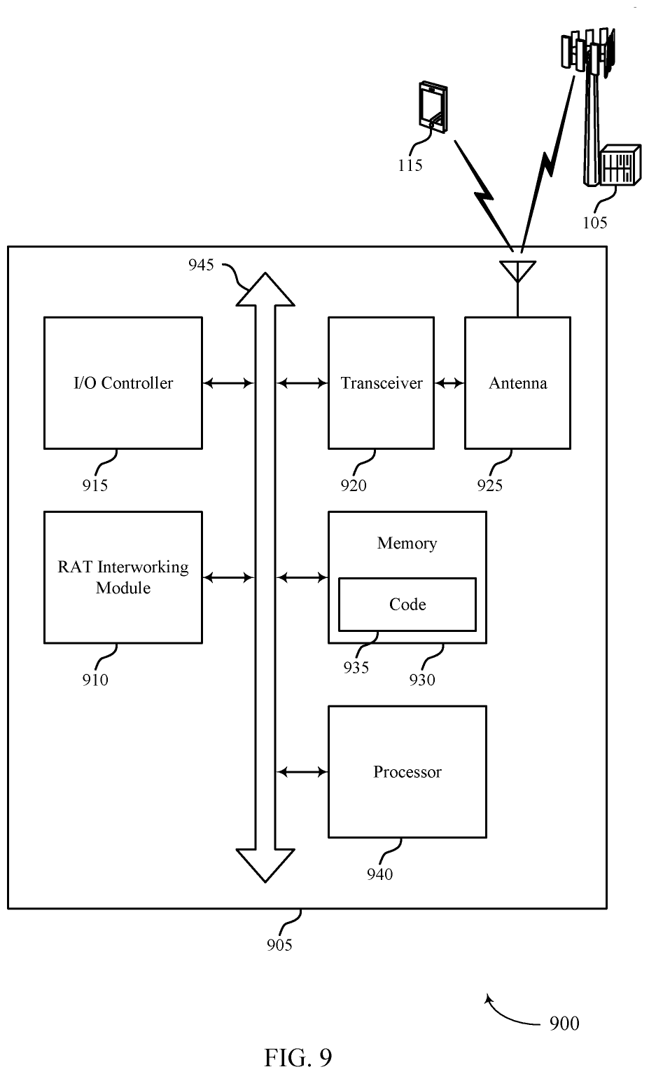

The receiver 610 may receive information such as packets, user data, or control information associated with various information channels (e.g., control channels, data channels, and information related to enabling interworking between multiple different RATs, etc.). Information may be passed on to other components of the device 605. The receiver 610 may be an example of aspects of the transceiver 920 described with reference to FIG. 9. The receiver 610 may utilize a single antenna or a set of antennas.

The RAT interworking module 615 may communicate with a network over a PDN connection using a first RAT, where the PDN connection is unassociated with a PDU session ID at the network for the first RAT, perform an inter-system change from the first RAT to a second RAT, and transmit, to the network using the second RAT, the PDU session ID corresponding to the PDN connection, the transmitting based on the performing the inter-system change from the first RAT to the second RAT and the PDN connection being unassociated with the PDU session ID at the network for the first RAT. The RAT interworking module 615 may be an example of aspects of the RAT interworking module 910 described herein.

The RAT interworking module 615, or its sub-components, may be implemented in hardware, code (e.g., software or firmware) executed by a processor, or any combination thereof. If implemented in code executed by a processor, the functions of the RAT interworking module 615, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The RAT interworking module 615, or its sub-components, may be physically located at various positions, including being distributed such that portions of functions are implemented at different physical locations by one or more physical components. In some examples, the RAT interworking module 615, or its sub-components, may be a separate and distinct component in accordance with various aspects of the present disclosure. In some examples, the RAT interworking module 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

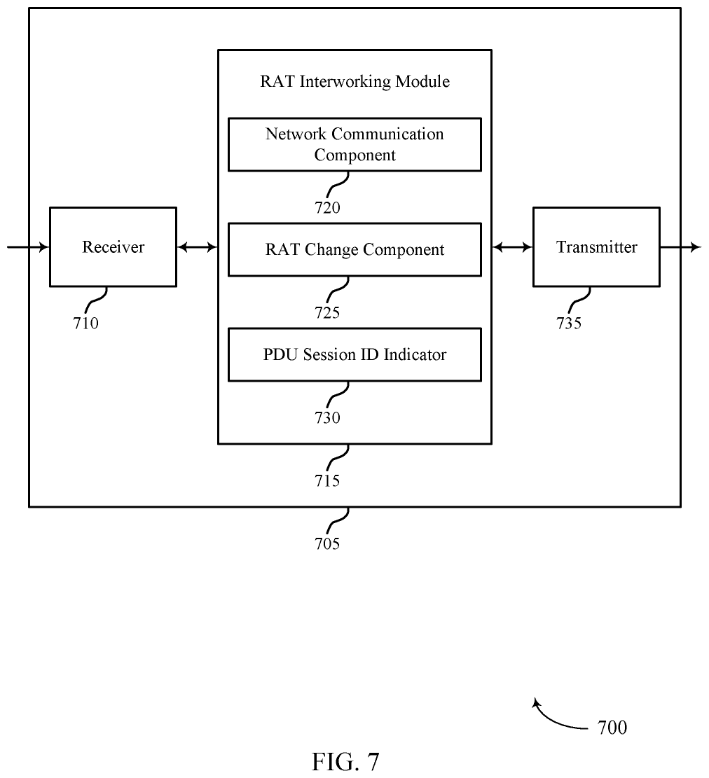

FIG. 7 shows a block diagram 700 of a device 705 that supports enabling interworking between multiple different RATs in accordance with one or more aspects of the present disclosure. The device 705 may be an example of aspects of a device 605 or a UE 115 as described herein. The device 705 may include a receiver 710, a RAT interworking module 715, and a transmitter 735. The device 705 may also include a processor. Each of these components may be in communication with one another (e.g., via one or more buses).

The receiver 710 may receive information such as packets, user data, or control information associated with various information channels (e.g., control channels, data channels, and information related to enabling interworking between multiple different RATs, etc.). Information may be passed on to other components of the device 705. The receiver 710 may be an example of aspects of the transceiver 920 described with reference to FIG. 9. The receiver 710 may utilize a single antenna or a set of antennas.

The RAT interworking module 715 may be an example of aspects of the RAT interworking module 615 as described herein. The RAT interworking module 715 may include a network communication component 720, a RAT change component 725, and a PDU session ID indicator 730. The RAT interworking module 715 may be an example of aspects of the RAT interworking module 910 described herein.

The network communication component 720 may communicate with a network over a PDN connection using a first RAT, where the PDN connection is unassociated with a PDU session ID at the network for the first RAT. The RAT change component 725 may perform an inter-system change from the first RAT to a second RAT. The PDU session ID indicator 730 may transmit, to the network using the second RAT, the PDU session ID corresponding to the PDN connection, the transmitting based on the performing the inter-system change from the first RAT to the second RAT and the PDN connection being unassociated with the PDU session ID at the network for the first RAT.

The transmitter 735 may transmit signals generated by other components of the device 705. In some examples, the transmitter 735 may be collocated with a receiver 710 in a transceiver module. For example, the transmitter 735 may be an example of aspects of the transceiver 920 described with reference to FIG. 9. The transmitter 735 may utilize a single antenna or a set of antennas.

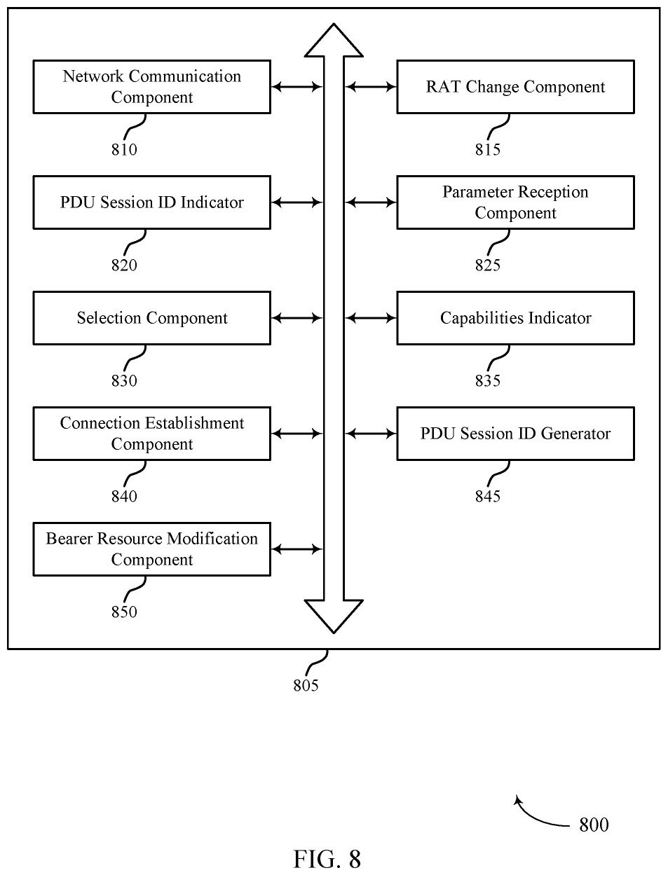

FIG. 8 shows a block diagram 800 of a RAT interworking module 805 that supports enabling interworking between multiple different RATs in accordance with one or more aspects of the present disclosure. The RAT interworking module 805 may be an example of aspects of a RAT interworking module 615, a RAT interworking module 715, or a RAT interworking module 910 described herein. The RAT interworking module 805 may include a network communication component 810, a RAT change component 815, a PDU session ID indicator 820, a parameter reception component 825, a selection component 830, a capabilities indicator 835, a connection establishment component 840, a PDU session ID generator 845, and a bearer resource modification component 850. Each of these modules may communicate, directly or indirectly, with one another (e.g., via one or more buses).

The network communication component 810 may communicate with a network over a PDN connection using a first RAT, where the PDN connection is unassociated with a PDU session ID at the network for the first RAT.

The RAT change component 815 may perform an inter-system change from the first RAT to a second RAT. In some cases, the inter-system change includes a connected mode handover inter-system change or an idle mode mobility inter-system change.

The PDU session ID indicator 820 may transmit, to the network using the second RAT, the PDU session ID corresponding to the PDN connection, the transmitting based on the performing the inter-system change from the first RAT to the second RAT and the PDN connection being unassociated with the PDU session ID at the network for the first RAT.

The parameter reception component 825 may receive, from the network using the second RAT, a mapped parameter for communication with the network using a third RAT. In some examples, the parameter reception component 825 may receive, from the network, a modify EPS bearer context request message including the mapped parameter for communication with the network using the third RAT. In some cases, a serving gateway for the communicating with the network is a PGW-C/SMF combination gateway. In some cases, the receiving the mapped parameter for communication with the network using the third RAT is based on the serving gateway being the PGW-C/SMF combination gateway. In some cases, the mapped parameter for communication with the network using the third RAT includes a QoS parameter for the third RAT.

The selection component 830 may select a subset of PDN connections from a total set of PDN connections with the network, where the subset of PDN connections is selected to enable support for performing inter-system changes from the second RAT to the third RAT, the subset of PDN connections includes the PDN connection, and the transmitting is based on the selecting.

In some examples, the RAT change component 815 may perform an additional inter-system change from the second RAT to the third RAT based on the receiving the mapped parameter for communication with the network using the third RAT. In some such examples, the network communication component 810 may communicate with the network over the PDN connection using the third RAT.

The capabilities indicator 835 may indicate, to the network, NAS capability for the third RAT based on the performing the inter-system change from the first RAT to the second RAT.

The connection establishment component 840 may establish the PDN connection with the network. The PDU session ID generator 845 may generate, for the PDN connection, the PDU session ID corresponding to the PDN connection based on the establishing the PDN connection. In some cases, the PDN connection is established with the network using the first RAT and the PDU session ID is generated transparent to the network for the first RAT. In some other cases, the PDN connection is established with the network using either the second RAT or a third RAT. In some such cases, the PDU session ID indicator 820 may transmit, to the network, the PDU session ID corresponding to the PDN connection based on the establishing the PDN connection with the network using either the second RAT or the third RAT. The RAT change component 815 may perform an additional inter-system change to the first RAT, where the communicating with the network over the PDN connection using the first RAT is based on the performing the additional inter-system change to the first RAT, and where the transmitting the PDU session ID corresponding to the PDN connection based on the performing the inter-system change from the first RAT to the second RAT further includes the PDU session ID indicator 820 re-transmitting, to the network, the PDU session ID corresponding to the PDN connection based on the performing the additional inter-system change to the first RAT.

The bearer resource modification component 850 may initiate a bearer resource modification procedure for the PDN connection and may transmit, to the network, a bearer resource modification request message including the PDU session ID corresponding to the PDN connection, where the transmitting the bearer resource modification request message is based on the initiating the bearer resource modification procedure, and where the bearer resource modification procedure is triggered based on the performing the inter-system change from the first RAT to the second RAT.

In some cases, the first RAT includes a GERAN RAT, a UTRAN RAT, a 2G RAT, a 3G RAT, or a combination thereof. In some cases, the second RAT includes an LTE RAT, a 4G RAT, an EPC RAT, an E-UTRAN RAT, or a combination thereof. In some cases, the third RAT includes an NG-RAN RAT, a 5G RAT, or a combination thereof.

FIG. 9 shows a diagram of a system 900 including a device 905 that supports enabling interworking between multiple different RATs in accordance with one or more aspects of the present disclosure. The device 905 may be an example of or include the components of device 605, device 705, or a UE 115 as described herein. The device 905 may include components for bi-directional voice and data communications including components for transmitting and receiving communications, including a RAT interworking module 910, an I/O controller 915, a transceiver 920, an antenna 925, memory 930, and a processor 940. These components may be in electronic communication via one or more buses (e.g., bus 945).

The RAT interworking module 910 may communicate with a network over a PDN connection using a first RAT, where the PDN connection is unassociated with a PDU session ID at the network for the first RAT, perform an inter-system change from the first RAT to a second RAT, and transmit, to the network using the second RAT, the PDU session ID corresponding to the PDN connection, the transmitting based on the performing the inter-system change from the first RAT to the second RAT and the PDN connection being unassociated with the PDU session ID at the network for the first RAT.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include random-access memory (RAM) and read-only memory (ROM). The memory 930 may store computer-readable, computer-executable code 935 including instructions that, when executed, cause the processor to perform various functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting enabling interworking between multiple different RATs).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

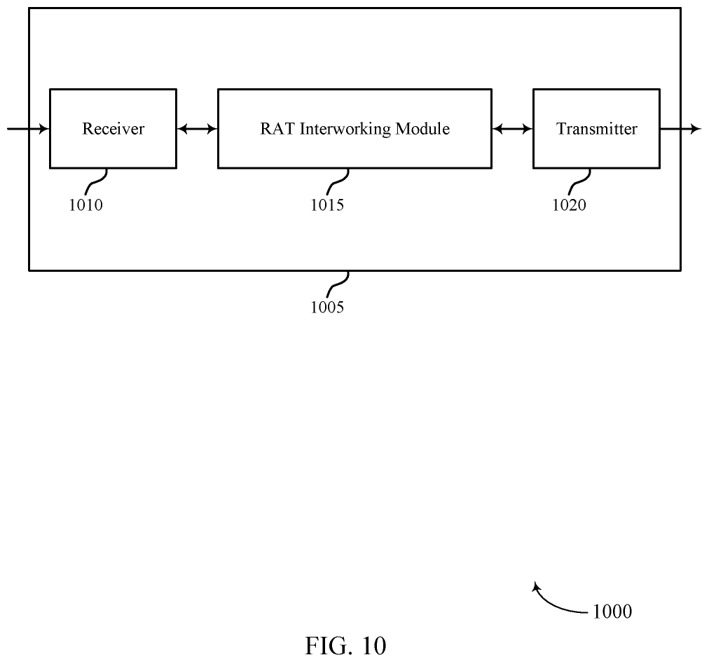

FIG. 10 shows a block diagram 1000 of a device 1005 that supports enabling interworking between multiple different RATs in accordance with one or more aspects of the present disclosure. The device 1005 may be an example of aspects of a network device (e.g., a base station 105, an AMF, etc.) as described herein. The device 1005 may include a receiver 1010, a RAT interworking module 1015, and a transmitter 1020. The device 1005 may also include a processor. Each of these components may be in communication with one another (e.g., via one or more buses).

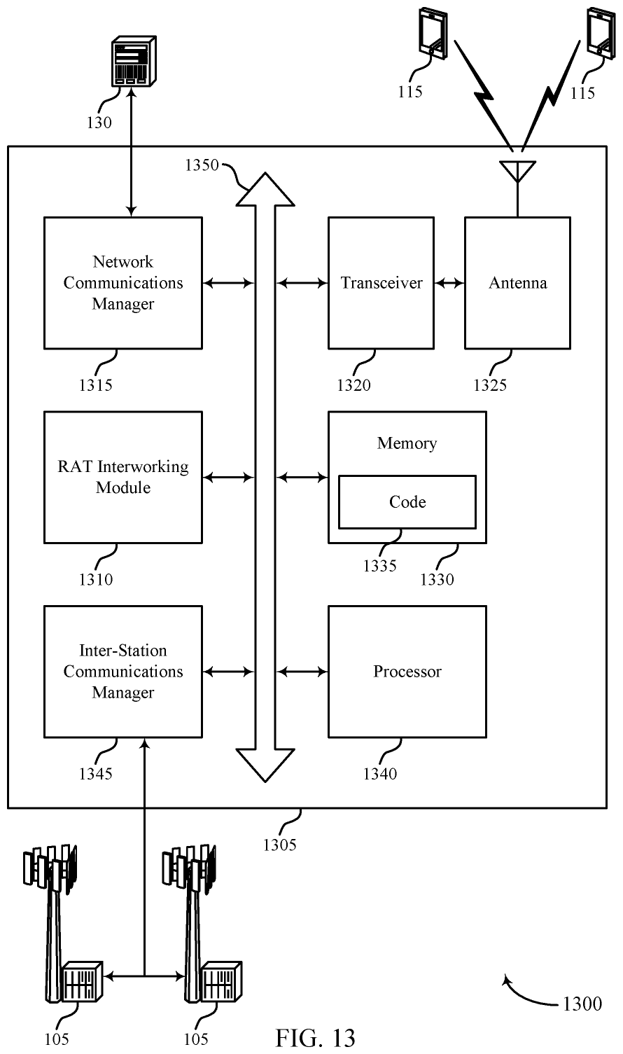

The receiver 1010 may receive information such as packets, user data, or control information associated with various information channels (e.g., control channels, data channels, and information related to enabling interworking between multiple different RATs, etc.). Information may be passed on to other components of the device 1005. The receiver 1010 may be an example of aspects of the transceiver 1320 described with reference to FIG. 13. The receiver 1010 may utilize a single antenna or a set of antennas.

The RAT interworking module 1015 may be implemented at a network device. The RAT interworking module 1015 may communicate with a UE, via a serving gateway, over a PDN connection using a first RAT, where the PDN connection is unassociated with a PDU session ID at the network device for the first RAT, perform an inter-system change from the first RAT to a second RAT, and receive, from the UE using the second RAT, the PDU session ID corresponding to the PDN connection, the receiving based on the performing the inter-system change from the first RAT to the second RAT and the PDN connection being unassociated with the PDU session ID at the network device for the first RAT. The RAT interworking module 1015 may be an example of aspects of the RAT interworking module 1310 described herein.

The RAT interworking module 1015, or its sub-components, may be implemented in hardware, code (e.g., software or firmware) executed by a processor, or any combination thereof. If implemented in code executed by a processor, the functions of the RAT interworking module 1015, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The RAT interworking module 1015, or its sub-components, may be physically located at various positions, including being distributed such that portions of functions are implemented at different physical locations by one or more physical components. In some examples, the RAT interworking module 1015, or its sub-components, may be a separate and distinct component in accordance with various aspects of the present disclosure. In some examples, the RAT interworking module 1015, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

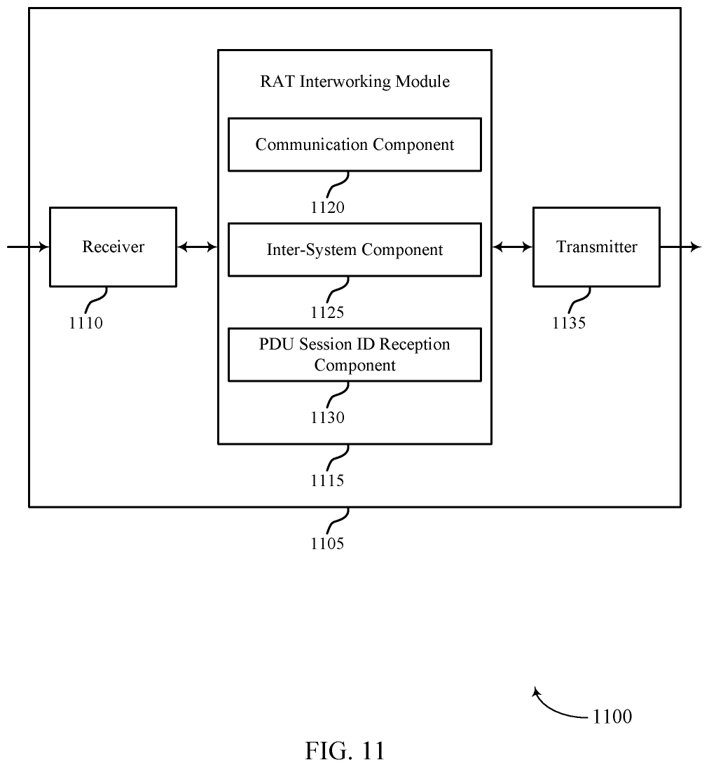

FIG. 11 shows a block diagram 1100 of a device 1105 that supports enabling interworking between multiple different RATs in accordance with one or more aspects of the present disclosure. The device 1105 may be an example of aspects of a device 1005 or a network device (e.g., a base station 105, an AMF, etc.) as described herein. The device 1105 may include a receiver 1110, a RAT interworking module 1115, and a transmitter 1135. The device 1105 may also include a processor. Each of these components may be in communication with one another (e.g., via one or more buses).

The receiver 1110 may receive information such as packets, user data, or control information associated with various information channels (e.g., control channels, data channels, and information related to enabling interworking between multiple different RATs, etc.). Information may be passed on to other components of the device 1105. The receiver 1110 may be an example of aspects of the transceiver 1320 described with reference to FIG. 13. The receiver 1110 may utilize a single antenna or a set of antennas.

The RAT interworking module 1115 may be an example of aspects of the RAT interworking module 1015 as described herein. The RAT interworking module 1115 may include a communication component 1120, an inter-system component 1125, and a PDU session ID reception component 1130. The RAT interworking module 1115 may be an example of aspects of the RAT interworking module 1310 described herein. The RAT interworking module 1115 may be implemented at a network device.

The communication component 1120 may communicate with a UE, via a serving gateway, over a PDN connection using a first RAT, where the PDN connection is unassociated with a PDU session ID at the network device for the first RAT. The inter-system component 1125 may perform an inter-system change from the first RAT to a second RAT.

The PDU session ID reception component 1130 may receive, from the UE using the second RAT, the PDU session ID corresponding to the PDN connection, the receiving based on the performing the inter-system change from the first RAT to the second RAT and the PDN connection being unassociated with the PDU session ID at the network device for the first RAT.

The transmitter 1135 may transmit signals generated by other components of the device 1105. In some examples, the transmitter 1135 may be collocated with a receiver 1110 in a transceiver module. For example, the transmitter 1135 may be an example of aspects of the transceiver 1320 described with reference to FIG. 13. The transmitter 1135 may utilize a single antenna or a set of antennas.

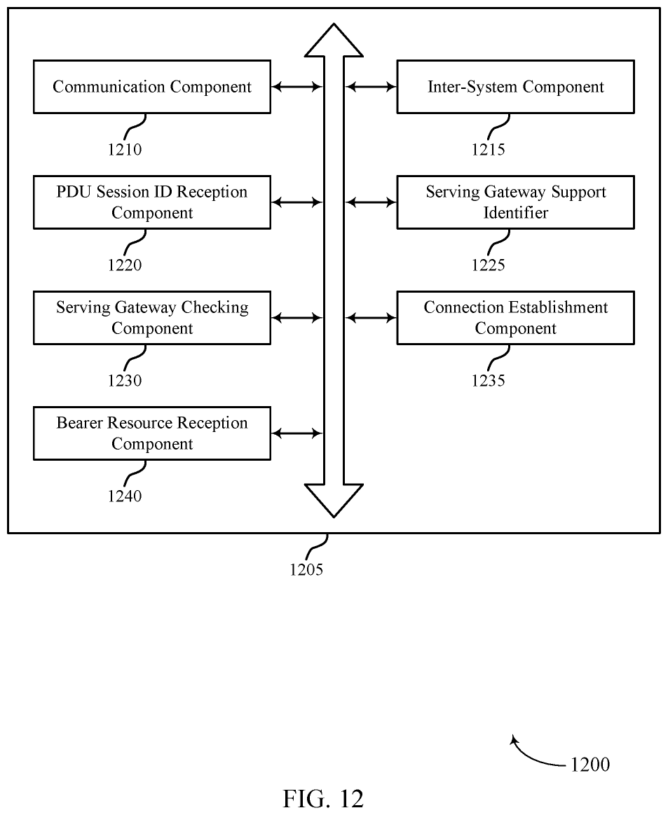

FIG. 12 shows a block diagram 1200 of a RAT interworking module 1205 that supports enabling interworking between multiple different RATs in accordance with one or more aspects of the present disclosure. The RAT interworking module 1205 may be an example of aspects of a RAT interworking module 1015, a RAT interworking module 1115, or a RAT interworking module 1310 described herein. The RAT interworking module 1205 may include a communication component 1210, an inter-system component 1215, a PDU session ID reception component 1220, a serving gateway support identifier 1225, a serving gateway checking component 1230, a connection establishment component 1235, and a bearer resource reception component 1240. Each of these modules may communicate, directly or indirectly, with one another (e.g., via one or more buses). The RAT interworking module 1205 may be implemented at a network device.

The communication component 1210 may communicate with a UE, via a serving gateway, over a PDN connection using a first RAT, where the PDN connection is unassociated with a PDU session ID at the network device for the first RAT.

The inter-system component 1215 may perform an inter-system change from the first RAT to a second RAT. The PDU session ID reception component 1220 may receive, from the UE using the second RAT, the PDU session ID corresponding to the PDN connection, the receiving based on the performing the inter-system change from the first RAT to the second RAT and the PDN connection being unassociated with the PDU session ID at the network device for the first RAT.

The serving gateway support identifier 1225 may determine, based on the received PDU session ID, whether the serving gateway supports a third RAT. In some examples, the serving gateway support identifier 1225 may determine that the serving gateway supports the third RAT and the communication component 1210 may transmit, to the UE using the second RAT, a response to the received PDU session ID, the response based on the determination, and where the response includes a mapped parameter for communication with the UE using the third RAT. In some cases, the mapped parameter for communication with the UE using the third RAT includes a set of quality of service parameters for the third RAT. In some examples, the communication component 1210 may transmit, to the UE, a modify EPS bearer context request message including the mapped parameter for communication with the UE using the third RAT.

In some examples, the inter-system component 1215 may perform an additional inter-system change of from the second RAT to the third RAT based on the mapped parameter for communication with the UE using the third RAT. In some such examples, the communication component 1210 may communicate with the UE, via the serving gateway, over the PDN connection using the third RAT.

In some examples, determining whether the serving gateway supports the third RAT involves the communication component 1210 transmitting the received PDU session ID to the serving gateway. In some examples, the PDU session ID reception component 1220 may receive, from the serving gateway, an indication that the serving gateway received and stored the received PDU session ID and the serving gateway checking component 1230 may determine that the serving gateway supports the third RAT based on the receiving the indication from the serving gateway. In some other examples, the serving gateway checking component 1230 may identify that an indication is not received from the serving gateway in response to the transmitting the received PDU session ID during a monitoring period and may determine that the serving gateway does not support the third RAT based on the identifying that the indication is not received during the monitoring period.

In some examples, determining whether the serving gateway supports the third RAT involves the serving gateway checking component 1230 verifying whether the serving gateway includes a PGW-C/SMF combination gateway.

The connection establishment component 1235 may select the serving gateway for the UE. In some examples, the connection establishment component 1235 may establish the PDN connection with the UE using the selected serving gateway. In some examples, the connection establishment component 1235 may identify that the UE supports communication using the third RAT, where selecting the serving gateway further includes selecting a PGW-C/SMF combination gateway for the UE based on the identifying that the UE supports communication using the third RAT.

The bearer resource reception component 1240 may receive, from the UE, a bearer resource modification request message including the PDU session ID corresponding to the PDN connection, where the receiving the bearer resource modification request message is based on a bearer resource modification procedure initiated by the UE.

In some cases, the first RAT includes a GERAN RAT, a UTRAN RAT, a 2G RAT, a 3G RAT, or a combination thereof. In some cases, the second RAT includes an LTE RAT, an EPC RAT, an E-UTRAN RAT, a 4G RAT, or a combination thereof. In some cases, the third RAT includes an NG-RAN RAT, a 5G RAT, or a combination thereof.

FIG. 13 shows a diagram of a system 1300 including a device 1305 that supports enabling interworking between multiple different RATs in accordance with one or more aspects of the present disclosure. The device 1305 may be an example of or include the components of device 1005, device 1105, or a network device (e.g., a base station 105, an AMF, etc.) as described herein. The device 1305 may include components for bi-directional voice and data communications including components for transmitting and receiving communications, including a RAT interworking module 1310, a network communications manager 1315, a transceiver 1320, an antenna 1325, memory 1330, a processor 1340, and an inter-station communications manager 1345. These components may be in electronic communication via one or more buses (e.g., bus 1350).

The RAT interworking module 1310 may be implemented at a network device (e.g., an AMF). The RAT interworking module 1310 may communicate with a UE, via a serving gateway, over a PDN connection using a first RAT, where the PDN connection is unassociated with a PDU session ID at the network device for the first RAT, perform an inter-system change from the first RAT to a second RAT, and receive, from the UE using the second RAT, the PDU session ID corresponding to the PDN connection, the receiving based on the performing the inter-system change from the first RAT to the second RAT and the PDN connection being unassociated with the PDU session ID at the network device for the first RAT.

The network communications manager 1315 may manage communications with the core network 130 (e.g., via one or more wired backhaul links). For example, the network communications manager 1315 may manage the transfer of data communications for client devices, such as one or more UEs 115.

The transceiver 1320 may communicate bi-directionally, via one or more antennas, wired, or wireless links as described above. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM, ROM, or a combination thereof. The memory 1330 may store computer-readable code 1335 including instructions that, when executed by a processor (e.g., the processor 1340) cause the device to perform various functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some cases, a memory controller may be integrated into processor 1340. The processor 1340 may be configured to execute computer-readable instructions stored in a memory (e.g., the memory 1330) to cause the device 1305 to perform various functions (e.g., functions or tasks supporting enabling interworking between multiple different RATs).

The inter-station communications manager 1345 may manage communications with other base station 105 and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communication network technology to provide communication between base stations 105.

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

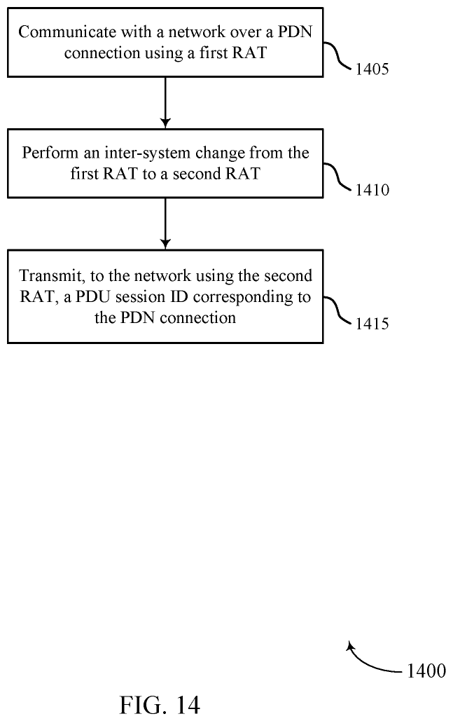

FIG. 14 shows a flowchart illustrating a method 1400 that supports enabling interworking between multiple different RATs in accordance with one or more aspects of the present disclosure. The operations of method 1400 may be implemented by a UE 115 or its components as described herein. For example, the operations of method 1400 may be performed by a RAT interworking module as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1405, the UE may communicate with a network over a PDN connection using a first RAT, where the PDN connection is unassociated with a PDU session ID at the network for the first RAT. The operations of 1405 may be performed according to the methods described herein. In some examples, aspects of the operations of 1405 may be performed by a network communication component as described with reference to FIGS. 6 through 9.

At 1410, the UE may perform an inter-system change from the first RAT to a second RAT. The operations of 1410 may be performed according to the methods described herein. In some examples, aspects of the operations of 1410 may be performed by a RAT change component as described with reference to FIGS. 6 through 9.

At 1415, the UE may transmit, to the network using the second RAT, the PDU session ID corresponding to the PDN connection, the transmitting based on the performing the inter-system change from the first RAT to the second RAT and the PDN connection being unassociated with the PDU session ID at the network for the first RAT. The operations of 1415 may be performed according to the methods described herein. In some examples, aspects of the operations of 1415 may be performed by a PDU session ID indicator as described with reference to FIGS. 6 through 9.

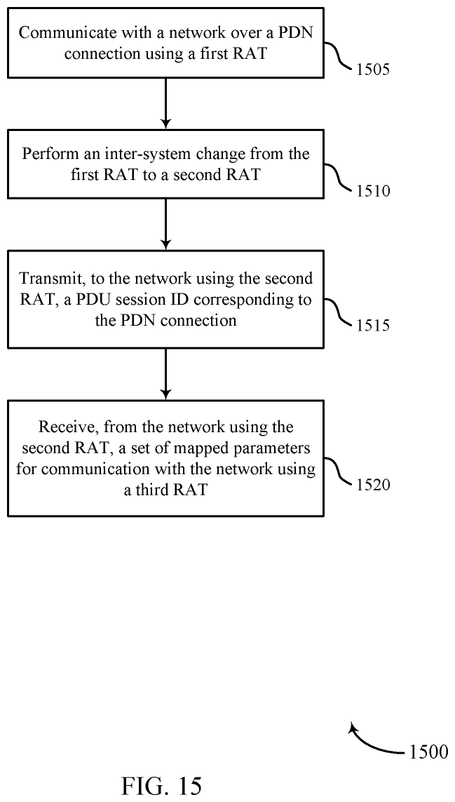

FIG. 15 shows a flowchart illustrating a method 1500 that supports enabling interworking between multiple different RATs in accordance with one or more aspects of the present disclosure. The operations of method 1500 may be implemented by a UE 115 or its components as described herein. For example, the operations of method 1500 may be performed by a RAT interworking module as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1505, the UE may communicate with a network over a PDN connection using a first RAT, where the PDN connection is unassociated with a PDU session ID at the network for the first RAT. The operations of 1505 may be performed according to the methods described herein. In some examples, aspects of the operations of 1505 may be performed by a network communication component as described with reference to FIGS. 6 through 9.

At 1510, the UE may perform an inter-system change from the first RAT to a second RAT. The operations of 1510 may be performed according to the methods described herein. In some examples, aspects of the operations of 1510 may be performed by a RAT change component as described with reference to FIGS. 6 through 9.

At 1515, the UE may transmit, to the network using the second RAT, the PDU session ID corresponding to the PDN connection, the transmitting based on the performing the inter-system change from the first RAT to the second RAT and the PDN connection being unassociated with the PDU session ID at the network for the first RAT. The operations of 1515 may be performed according to the methods described herein. In some examples, aspects of the operations of 1515 may be performed by a PDU session ID indicator as described with reference to FIGS. 6 through 9.

At 1520, the UE may receive, from the network using the second RAT, a mapped parameter for communication with the network using a third RAT. The operations of 1520 may be performed according to the methods described herein. In some examples, aspects of the operations of 1520 may be performed by a parameter reception component as described with reference to FIGS. 6 through 9.

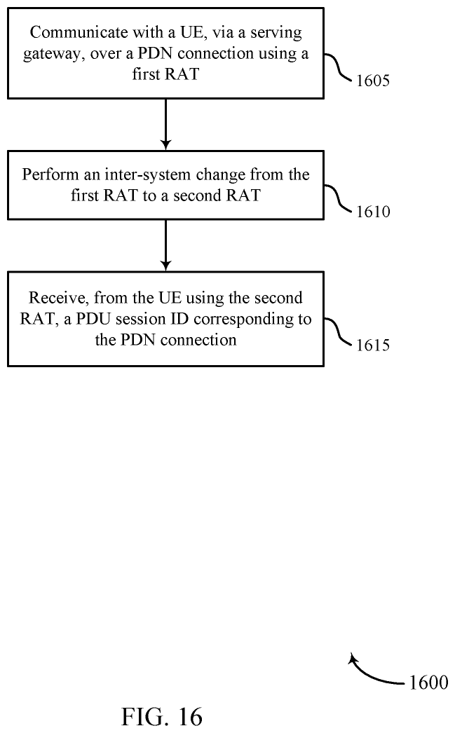

FIG. 16 shows a flowchart illustrating a method 1600 that supports enabling interworking between multiple different RATs in accordance with one or more aspects of the present disclosure. The operations of method 1600 may be implemented by a network device (e.g., a base station 105, an AMF, etc.) or its components as described herein. For example, the operations of method 1600 may be performed by a RAT interworking module as described with reference to FIGS. 10 through 13. In some examples, a network device may execute a set of instructions to control the functional elements of the network device to perform the functions described below. Additionally or alternatively, a network device may perform aspects of the functions described below using special-purpose hardware.

At 1605, the network device may communicate with a UE, via a serving gateway, over a PDN connection using a first RAT, where the PDN connection is unassociated with a PDU session ID at the network device for the first RAT. The operations of 1605 may be performed according to the methods described herein. In some examples, aspects of the operations of 1605 may be performed by a communication component as described with reference to FIGS. 10 through 13.

At 1610, the network device may perform an inter-system change from the first RAT to a second RAT. The operations of 1610 may be performed according to the methods described herein. In some examples, aspects of the operations of 1610 may be performed by an inter-system component as described with reference to FIGS. 10 through 13.

At 1615, the network device may receive, from the UE using the second RAT, the PDU session ID corresponding to the PDN connection, the receiving based on the performing the inter-system change from the first RAT to the second RAT and the PDN connection being unassociated with the PDU session ID at the network device for the first RAT. The operations of 1615 may be performed according to the methods described herein. In some examples, aspects of the operations of 1615 may be performed by a PDU session ID reception component as described with reference to FIGS. 10 through 13.

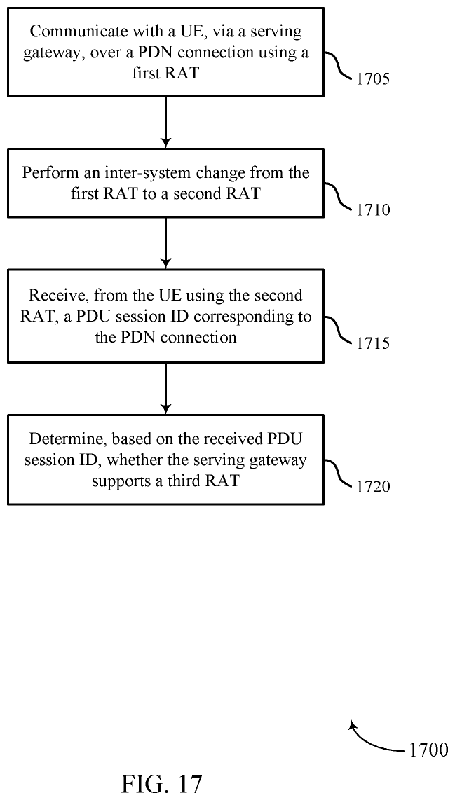

FIG. 17 shows a flowchart illustrating a method 1700 that supports enabling interworking between multiple different RATs in accordance with one or more aspects of the present disclosure. The operations of method 1700 may be implemented by a network device or its components as described herein. For example, the operations of method 1700 may be performed by a RAT interworking module as described with reference to FIGS. 10 through 13. In some examples, a network device may execute a set of instructions to control the functional elements of the network device to perform the functions described below. Additionally or alternatively, a network device may perform aspects of the functions described below using special-purpose hardware.

At 1705, the network device may communicate with a UE, via a serving gateway, over a PDN connection using a first RAT, where the PDN connection is unassociated with a PDU session ID at the network device for the first RAT. The operations of 1705 may be performed according to the methods described herein. In some examples, aspects of the operations of 1705 may be performed by a communication component as described with reference to FIGS. 10 through 13.

At 1710, the network device may perform an inter-system change from the first RAT to a second RAT. The operations of 1710 may be performed according to the methods described herein. In some examples, aspects of the operations of 1710 may be performed by an inter-system component as described with reference to FIGS. 10 through 13.

At 1715, the network device may receive, from the UE using the second RAT, the PDU session ID corresponding to the PDN connection, the receiving based on the performing the inter-system change from the first RAT to the second RAT and the PDN connection being unassociated with the PDU session ID at the network device for the first RAT. The operations of 1715 may be performed according to the methods described herein. In some examples, aspects of the operations of 1715 may be performed by a PDU session ID reception component as described with reference to FIGS. 10 through 13.

At 1720, the network device may determine, based on the received PDU session ID, whether the serving gateway supports a third RAT. The operations of 1720 may be performed according to the methods described herein. In some examples, aspects of the operations of 1720 may be performed by a serving gateway support identifier as described with reference to FIGS. 10 through 13.

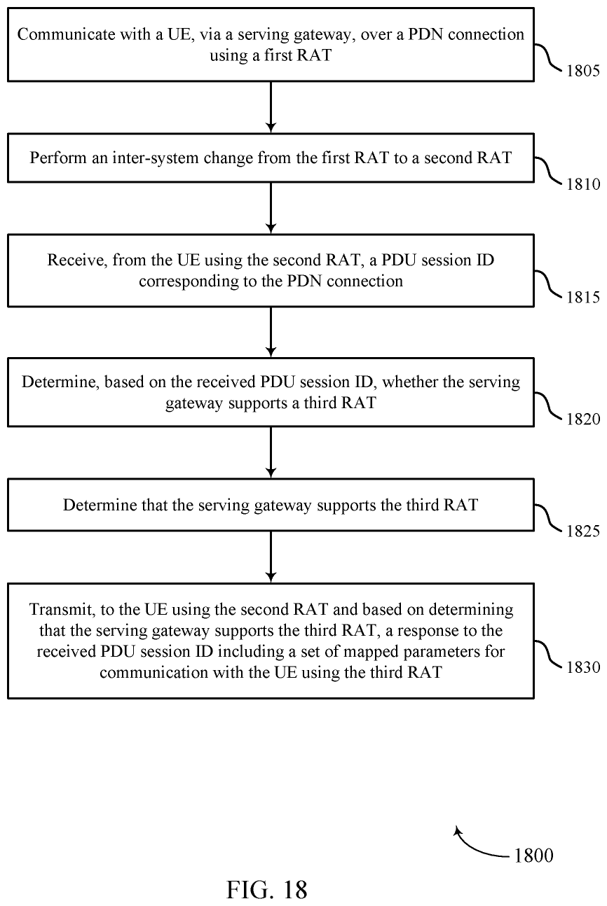

FIG. 18 shows a flowchart illustrating a method 1800 that supports enabling interworking between multiple different RATs in accordance with one or more aspects of the present disclosure. The operations of method 1800 may be implemented by a network device or its components as described herein. For example, the operations of method 1800 may be performed by a RAT interworking module as described with reference to FIGS. 10 through 13. In some examples, a network device may execute a set of instructions to control the functional elements of the network device to perform the functions described below. Additionally or alternatively, a network device may perform aspects of the functions described below using special-purpose hardware.

At 1805, the network device may communicate with a UE, via a serving gateway, over a PDN connection using a first RAT, where the PDN connection is unassociated with a PDU session ID at the network device for the first RAT. The operations of 1805 may be performed according to the methods described herein. In some examples, aspects of the operations of 1805 may be performed by a communication component as described with reference to FIGS. 10 through 13.

At 1810, the network device may perform an inter-system change from the first RAT to a second RAT. The operations of 1810 may be performed according to the methods described herein. In some examples, aspects of the operations of 1810 may be performed by an inter-system component as described with reference to FIGS. 10 through 13.

At 1815, the network device may receive, from the UE using the second RAT, the PDU session ID corresponding to the PDN connection, the receiving based on the performing the inter-system change from the first RAT to the second RAT and the PDN connection being unassociated with the PDU session ID at the network device for the first RAT. The operations of 1815 may be performed according to the methods described herein. In some examples, aspects of the operations of 1815 may be performed by a PDU session ID reception component as described with reference to FIGS. 10 through 13.

At 1820, the network device may determine, based on the received PDU session ID, whether the serving gateway supports a third RAT. The operations of 1820 may be performed according to the methods described herein. In some examples, aspects of the operations of 1820 may be performed by a serving gateway support identifier as described with reference to FIGS. 10 through 13.

At 1825, the network device may determine that the serving gateway supports the third RAT. The operations of 1825 may be performed according to the methods described herein. In some examples, aspects of the operations of 1825 may be performed by a serving gateway support identifier as described with reference to FIGS. 10 through 13.

At 1830, the network device may transmit, to the UE using the second RAT, a response to the received PDU session ID, the response based on the determination, and where the response includes a mapped parameter for communication with the UE using the third RAT. The operations of 1830 may be performed according to the methods described herein. In some examples, aspects of the operations of 1830 may be performed by a communication component as described with reference to FIGS. 10 through 13.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as CDMA, TDMA, FDMA, OFDMA, single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as GSM.

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of UMTS. LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs 115 with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
communicating with a network over a packet data network connection using a first radio access technology (RAT), wherein the packet data network connection is unassociated with a protocol data unit session identifier at the network for the first RAT;
performing an inter-system change from the first RAT to a second RAT; and
transmitting, to the network using the second RAT, the protocol data unit session identifier corresponding to the packet data network connection, the transmitting based at least in part on the performing the inter-system change from the first RAT to the second RAT and the packet data network connection being unassociated with the protocol data unit session identifier at the network for the first RAT.

2. The method of claim 1, further comprising:
receiving, from the network using the second RAT, a mapped parameter for communication with the network using a third RAT.

3. The method of claim 2, further comprising:
selecting a subset of packet data network connections from a total set of packet data network connections with the network, wherein the subset of packet data network connections is selected to enable support for performing inter-system changes from the second RAT to the third RAT, the subset of packet data network connections comprising the packet data network connection, and the transmitting being based at least in part on the selecting.

4. The method of claim 2, further comprising:
performing an additional inter-system change from the second RAT to the third RAT based at least in part on the receiving the mapped parameter for communication with the network using the third RAT; and
communicating with the network over the packet data network connection using the third RAT.

5. The method of claim 2, further comprising:
indicating, to the network, non-access stratum capability for the third RAT based at least in part on the performing the inter-system change from the first RAT to the second RAT.

6. The method of claim 2, wherein receiving the mapped parameter for communication with the network using the third RAT further comprises:
receiving, from the network, a modify evolved packet system (EPS) bearer context request message comprising the mapped parameter for communication with the network using the third RAT.

7. The method of claim 2, wherein:
a serving gateway for the communicating with the network comprises a packet data network gateway-control (PGW-C)/session management function (SMF) combination gateway; and
the receiving the mapped parameter for communication with the network using the third RAT is based at least in part on the serving gateway comprising the PGW-C/SMF combination gateway.

8. The method of claim 2, wherein the mapped parameter for communication with the network using the third RAT comprises a quality of service (QoS) parameter for the third RAT.

9. The method of claim 2, wherein:
the first RAT comprises a global system for mobile communications (GSM) enhanced data rates for GSM evolution (EDGE) radio access network (GERAN) RAT, a universal mobile telecommunication system (UMTS) terrestrial radio access network (UTRAN) RAT, a second generation (2G) RAT, a third generation (3G) RAT, or a combination thereof;
the second RAT comprises a long term evolution (LTE) RAT, a fourth generation (4G) RAT, an evolved packet core (EPC) RAT, an evolved UTRAN (E-UTRAN) RAT, or a combination thereof; and
the third RAT comprises a next generation radio access network (NG-RAN) RAT, a fifth generation (5G) RAT, or a combination thereof.

10. The method of claim 1, wherein the inter-system change comprises a connected mode handover inter-system change or an idle mode mobility inter-system change.

11. The method of claim 1, further comprising:
establishing the packet data network connection with the network; and
generating, for the packet data network connection, the protocol data unit session identifier corresponding to the packet data network connection based at least in part on the establishing the packet data network connection.

12. The method of claim 11, wherein:
the packet data network connection is established with the network using the first RAT; and
the protocol data unit session identifier is generated transparent to the network for the first RAT.

13. The method of claim 11, wherein the packet data network connection is established with the network using either the second RAT or a third RAT, the method further comprising:
transmitting, to the network, the protocol data unit session identifier corresponding to the packet data network connection based at least in part on the establishing the packet data network connection with the network using either the second RAT or the third RAT; and
performing an additional inter-system change to the first RAT, wherein the communicating with the network over the packet data network connection using the first RAT is based at least in part on the performing the additional inter-system change to the first RAT, and wherein the transmitting the protocol data unit session identifier corresponding to the packet data network connection based at least in part on the performing the inter-system change from the first RAT to the second RAT further comprises:
re-transmitting, to the network, the protocol data unit session identifier corresponding to the packet data network connection based at least in part on the performing the additional inter-system change to the first RAT.

14. The method of claim 1, wherein transmitting the protocol data unit session identifier corresponding to the packet data network connection further comprises:
initiating a bearer resource modification procedure for the packet data network connection; and
transmitting, to the network, a bearer resource modification request message comprising the protocol data unit session identifier corresponding to the packet data network connection, wherein the transmitting the bearer resource modification request message is based at least in part on the initiating the bearer resource modification procedure, and wherein the bearer resource modification procedure is triggered based at least in part on the performing the inter-system change from the first RAT to the second RAT.

15. A method for wireless communications at a network device, comprising:
communicating with a user equipment (UE), via a serving gateway, over a packet data network connection using a first radio access technology (RAT), wherein the packet data network connection is unassociated with a protocol data unit session identifier at the network device for the first RAT;
performing an inter-system change from the first RAT to a second RAT; and
receiving, from the UE using the second RAT, the protocol data unit session identifier corresponding to the packet data network connection, the receiving based at least in part on the performing the inter-system change from the first RAT to the second RAT and the packet data network connection being unassociated with the protocol data unit session identifier at the network device for the first RAT.

16. The method of claim 15, further comprising:
determining, based at least in part on the received protocol data unit session identifier, whether the serving gateway supports a third RAT.

17. The method of claim 16, wherein the determining whether the serving gateway supports the third RAT further comprises:
determining that the serving gateway supports the third RAT; and
transmitting, to the UE using the second RAT, a response to the received protocol data unit session identifier, the response based at least in part on the determination, wherein the response comprises a mapped parameter for communication with the UE using the third RAT.

18. The method of claim 17, wherein the mapped parameter for communication with the UE using the third RAT comprises a quality of service parameter for the third RAT.

19. The method of claim 17, wherein transmitting the response comprises:
transmitting, to the UE, a modify evolved packet system (EPS) bearer context request message comprising the mapped parameter for communication with the UE using the third RAT.

20. The method of claim 17, further comprising:
performing an additional inter-system change from the second RAT to the third RAT based at least in part on the mapped parameter for communication with the UE using the third RAT; and
communicating with the UE, via the serving gateway, over the packet data network connection using the third RAT.

21. The method of claim 16, wherein determining whether the serving gateway supports the third RAT further comprises:
transmitting the received protocol data unit session identifier to the serving gateway.

22. The method of claim 21, wherein determining whether the serving gateway supports the third RAT further comprises:
receiving, from the serving gateway, an indication that the serving gateway received and stored the received protocol data unit session identifier; and
determining that the serving gateway supports the third RAT based at least in part on the receiving the indication from the serving gateway.

23. The method of claim 21, wherein determining whether the serving gateway supports the third RAT further comprises:
identifying that an indication is not received from the serving gateway in response to the transmitting the received protocol data unit session identifier during a monitoring period; and
determining that the serving gateway does not support the third RAT based at least in part on the identifying that the indication is not received during the monitoring period.

24. The method of claim 16, wherein determining whether the serving gateway supports the third RAT further comprises:
verifying whether the serving gateway comprises a packet data network gateway-control (PGW-C)/session management function (SMF) combination gateway.

25. The method of claim 16, further comprising:
selecting the serving gateway for the UE; and
establishing the packet data network connection with the UE using the selected serving gateway.

26. The method of claim 25, further comprising:
identifying that the UE supports communication using the third RAT, wherein selecting the serving gateway further comprises:
selecting a packet data network gateway-control (PGW-C)/session management function (SMF) combination gateway for the UE based at least in part on the identifying that the UE supports communication using the third RAT.

27. The method of claim 16, wherein receiving the protocol data unit session identifier corresponding to the packet data network connection further comprises:
receiving, from the UE, a bearer resource modification request message comprising the protocol data unit session identifier corresponding to the packet data network connection, wherein the receiving the bearer resource modification request message is based at least in part on a bearer resource modification procedure initiated by the UE.

28. The method of claim 16, wherein:
the first RAT comprises a global system for mobile communications (GSM) enhanced data rates for GSM evolution (EDGE) radio access network (GERAN) RAT, a universal mobile telecommunication system (UMTS) terrestrial radio access network (UTRAN) RAT, a second generation (2G) RAT, a third generation (3G) RAT, or a combination thereof;
the second RAT comprises a long term evolution (LTE) RAT, an evolved packet core (EPC) RAT, an evolved UTRAN (E-UTRAN) RAT, a fourth generation (4G) RAT, or a combination thereof; and
the third RAT comprises a next generation radio access network (NG-RAN) RAT, a fifth generation (5G) RAT, or a combination thereof.

29. An apparatus for wireless communications at a user equipment (UE), comprising:
a processor; and
memory coupled to the processor, the processor and the memory configured to:
communicate with a network over a packet data network connection using a first radio access technology (RAT), wherein the packet data network connection is unassociated with a protocol data unit session identifier at the network for the first RAT;
perform an inter-system change from the first RAT to a second RAT; and
transmit, to the network using the second RAT, the protocol data unit session identifier corresponding to the packet data network connection, the transmitting based at least in part on the performing the inter-system change from the first RAT to the second RAT and the packet data network connection being unassociated with the protocol data unit session identifier at the network for the first RAT.

30. An apparatus for wireless communications at a network device, comprising:
a processor; and
memory coupled to the processor, the processor and the memory configured to:
communicate with a user equipment (UE), via a serving gateway, over a packet data network connection using a first radio access technology (RAT), wherein the packet data network connection is unassociated with a protocol data unit session identifier at the network device for the first RAT;
perform an inter-system change from the first RAT to a second RAT; and
receive, from the UE using the second RAT, the protocol data unit session identifier corresponding to the packet data network connection, the receiving based at least in part on the performing the inter-system change from the first RAT to the second RAT and the packet data network connection being unassociated with the protocol data unit session identifier at the network device for the first RAT.
